(19) United States
(12) Patent Application Publication
(10) Pub. No.: US 2022/0297252 A1
(43) Pub. Date: Sep. 22, 2022

(54) Machine Tool Device

(71) Applicant: Robert Bosch GmbH, Stuttgart (DE)

(72) Inventors: Simon Riggenmann, Stuttgart (DE); Daniel Dennis, Nuertingen (DE); Juergen Wiker, Stuttgart (DE); Florian Esenwein, Leinfelden-Echterdingen (DE)

(21) Appl. No.: 17/753,363

(22) PCT Filed: Sep. 1, 2020
(86) PCT No.: PCT/EP2020/074289

§ 371 Date: Feb. 28, 2022

(30) Foreign Application Priority Data
Sep. 2, 2019 (DE) 10 2019 213 216.2
May 29, 2020 (DE) 10 2020 206 756.2

(51) Int. Cl. B23Q 17/24; B25F 5/00; B23Q 11/00

(52) U.S. Cl. CPC B23Q 17/2438; B25F 5/00; B23Q 11/0092

(57) ABSTRACT

A machine tool device includes at least one motor-driven machining tool; at least one sensor unit, in particular a capacitive sensor unit, which is configured to detect at least one foreign body in at least one detection area around the machining tool; and at least one open-loop and/or closed-loop control unit configured to trigger at least one action in accordance with at least one signal from the sensor unit. The sensor unit includes at least one antenna configured to emit at least one electric and/or magnetic field defining the at least one detection area and/or to detect the at least one foreign body in accordance with at least one change in at least one electric and/or magnetic field.

### PRIOR ART

A power tool device having at least one motor-drivable machining tool, having at least one, in particular capacitive, sensor unit which is configured to sense at least one foreign body in at least one detection area around the machining tool, and having at least one open-loop and/or closed-loop control unit which is configured to trigger at least one action on the basis of at least one signal from the sensor unit, has already been proposed.

### SUMMARY OF THE INVENTION

The invention proceeds from a power tool device having at least one motor-drivable machining tool, having at least one, in particular capacitive, sensor unit which is configured to sense at least one foreign body in at least one detection area around the machining tool, and having at least one open-loop and/or closed-loop control unit which is configured to trigger at least one action on the basis of at least one signal from the sensor unit.

It is proposed that the sensor unit comprises at least one antenna which is configured to emit at least one electric and/or magnetic field which defines the at least one detection area, and/or to sense the at least one foreign body on the basis of at least one change in at least one electric and/or magnetic field.

Preferably, a power tool comprises the power tool device. Preferably, the power tool device is in the form of a hand-held power tool device. In particular, the power tool that comprises the power tool device is in the form of a hand-held power tool. Preferably, the power tool device is in the form of an electrically powered power tool device. In particular, the power tool is in the form of an electric power tool. In particular, the machining tool is able to be driven by at least one electric motor of the power tool device. Preferably, the power tool device comprises at least one electrical energy storage unit, in particular a rechargeable battery, for supplying at least the electric motor with energy. Alternatively, it is conceivable for the power tool device to be in the form of a pneumatically powered power tool device, of a gasoline-powered power tool device or the like. Preferably, the power tool device is intended for cutting, sawing, planing, grinding or sanding, milling, nailing, drilling or machining a workpiece in some other way that appears to make sense to a person skilled in the art. In particular, the power tool can be in the form of a saw, in particular of a jigsaw, of a reciprocating saw, of a chain saw or the like, of a nail gun, of a hedge trimmer, of garden shears, of a milling machine, in particular of a router or of a trimmer, or the like. Alternatively, it is conceivable for the power tool to be in the form of a plunge cut saw, of a tacker, of a tenon saw, of a foam saw, of a drywall cutter, of a plate jointer, of a belt grinder or sander, of a rotary tool, of a multi-cutter, of an, in particular autonomous, lawnmower, of a drilling machine, of an impact hammer, of a drywall screwdriver, of a heat gun, of a brushcutter, of a chopper, or of some other power tool that appears to make sense to a person skilled in the art. In particular, the machining tool is in the form of a saw blade, in particular of a jigsaw blade or of a reciprocating saw blade, of a saw chain, of a nail, of a blade, of a milling tool or of some other machining tool that appears to make sense to a person skilled in the art. The term “intended” should be understood in particular as meaning especially equipped and/or especially configured. The term “configured” should be understood in particular as meaning especially programmed and/or especially designed. The fact that an object is intended or configured for a particular function should be understood in particular as meaning that the object fulfils and/or carries out this particular function in at least one use and/or operating state.

The sensor unit is preferably in the form of an electric, in particular of a capacitive, sensor unit. In particular, the sensor unit is configured differently than an optical, acoustic, haptic or similar sensor unit. In particular, the sensor unit is configured for proximity detection. Preferably, the sensor unit is configured to sense the foreign body prior to contact with the machining tool. In particular, the sensor unit is configured to sense the foreign body at at least a particular distance from the machining tool, in particular within the detection area around the machining tool. The detection area is in particular an area which extends around the machining tool and in which the sensor unit is able and set up to detect the foreign body. Preferably, the detection area extends asymmetrically around the machining tool. Preferably, the detection area has a greater extent around points of the machining tool that represent a risk to a user of the power tool device, in particular along a cutting edge of the machining tool, than at other points of the machining tool. Alternatively, it is conceivable for the detection area to extend symmetrically, in particular spherically, around the machining tool.

A “foreign body” should be understood in particular as being an object that is located in the detection area or an object that moves into the detection area and in particular impedes a machining operation. The foreign body may in particular be in the form of a living object, in particular of at least one body part of the user, for example a hand, a finger, a leg or the like, of an animal or of some other living object that appears to make sense to a person skilled in the art. The foreign body can in particular be in the form of an inanimate object, in particular of a disruptive object arranged on the workpiece and/or extending in the vicinity of the workpiece, for example of a nail, of a power line, of a water pipe or the like.

An “open-loop and/or closed-loop control unit” should be understood in particular as meaning a unit having at least one set of control electronics. “Control electronics” should be understood in particular as meaning a unit having a processor unit and having a memory unit, and having an operating program stored in the memory unit. Preferably, the open-loop and/or closed-loop control unit is connected to the sensor unit for signal transmission purposes, in particular via at least one signal line. Alternatively or additionally, it is conceivable for the open-loop and/or closed-loop control unit to be connected to the sensor unit for signal transmission purposes via a wireless signal connection. Preferably, the open-loop and/or closed-loop control unit is configured to control the sensor unit. The sensor unit is in particular configured to provide the at least one signal, preferably a plurality of signals, to the open-loop and/or closed-loop control unit, in particular on the basis of the at least one foreign body being sensed in the detection area. Preferably, the open-loop and/or closed-loop control unit is configured to evaluate the at least one signal received from the sensor unit. In particular, the open-loop and/or closed-loop control unit is configured to trigger the at least one action on the basis of an evaluation of the at least one signal from the sensor unit.

The at least one action is preferably in the form of a safety function, in particular for preventing or at least for minimizing injury to the user, and/or of a comfort function, in particular for making it easier for the user to operate the power tool device. The at least one action can in particular be in the form of braking of the machining tool, of moving the machining tool out of a risk area, of shielding the machining tool, of outputting at least one, in particular visual, audible and/or haptic, warning, of making an emergency call, or of some other action that appears to make sense to a person skilled in the art. In particular, the open-loop and/or closed-loop control unit can be configured to trigger a plurality of, in particular different, actions. Preferably, the open-loop and/or closed-loop control unit can be configured to trigger different actions on the basis of different signals from the sensor unit. In particular, the open-loop and/or closed-loop control unit is configured, on the basis of the at least one signal from the sensor unit, in particular for triggering the at least one action, to control at least one reaction unit of the power tool device which is intended to carry out the at least one action. The at least one reaction unit can in particular be in the form of a brake unit, of a covering unit, of a pivoting unit, of a blocking unit, of a signal output unit, of a communications unit, or of some other unit that appears to make sense to a person skilled in the art.

The at least one antenna is preferably configured to conduct electric power. In particular, the at least one antenna is formed in a cylindrical, in particular circular cylindrical, manner. In particular, the at least one antenna is configured to emit an electric field that is distributed radially symmetrically about a longitudinal axis of the antenna, and/or to emit a magnetic field that is distributed concentrically about the longitudinal axis of the antenna. A “longitudinal axis” of an, in particular circular cylindrical, object should be understood in particular as being an axis which is oriented perpendicularly to a cross-sectional area of the object that is defined by transverse extensions, in particular cylinder radii, of the object. The term “perpendicular” should be understood in particular as defining an orientation of a direction relative to a reference direction, wherein the direction and the reference direction, in particular as seen in a projection plane, enclose an angle of 90° and the angle has a maximum deviation of in particular less than 8°, advantageously less than 5° and particularly advantageously less than 2°. Preferably, the at least one antenna is in the form of a cable, in particular of a coaxial cable, of a wire or the like. It is also conceivable for the antenna to be formed from a plurality of electrodes. As a result, advantageously a zone of influence of the generated electric and/or magnetic field can be controlled. Alternatively or additionally, it is conceivable for the machining tool and/or an output shaft on which the machining tool is mounted to form the at least one antenna, and/or for the at least one antenna to be configured to be electrically coupled to the machining tool and/or to the output shaft. Preferably, the machining tool is in the form of the at least one antenna, wherein the sensor unit has at least one further antenna, which is formed separately from the machining tool. Alternatively or additionally, it is conceivable for the at least one antenna to be formed separately from the power tool device, in particular to be arranged on the user, for example on a glove or on protective goggles of the user.

In particular, the at least one antenna is configured to emit at least one electromagnetic field. In particular, the electric and/or magnetic, in particular electromagnetic, field of the at least one antenna, in particular a field strength and/or a maximum extent of the electric and/or magnetic field of the at least one antenna, is dependent on an electric voltage applied to the at least one antenna and/or on an electric current flowing through the at least one antenna. In particular, the detection area has at least substantially an identical shape to the electric and/or magnetic, in particular electromagnetic, field of the at least one antenna. In particular, a boundary of the detection area is defined by a sum of all the distances around the at least one antenna which have an identical minimum, in particular predefined, field strength of the electric and/or magnetic field of the at least one antenna. Preferably, the at least one antenna is arranged in the vicinity of the machining tool. In particular, the sensor unit can have a plurality of antennas, in particular to realize full coverage of the machining tool with a detection area. In particular, the sensor unit can have at least two antennas, preferably at least four antennas, particularly preferably at least six antennas, and very particularly preferably at least 8 antennas.

Preferably, the at least one antenna is configured to sense the foreign body on the basis of a change in the electric and/or magnetic field emitted by the at least one antenna. Alternatively or additionally, it is conceivable for the at least one antenna to be configured to sense the foreign body on the basis of a change in a further electric and/or magnetic field, in particular one emitted by another antenna. In particular, the sensor unit can comprise at least two antennas, wherein a first antenna is configured to emit an electric and/or magnetic field and wherein a second antenna is configured to sense the foreign body on the basis of a change in the electric and/or magnetic field of the first antenna. In particular, the foreign body arranged in the detection area changes the electric and/or magnetic field, in particular characteristics of the electric and/or magnetic field, in particular on the basis of electrical and/or magnetic properties of the foreign body. Preferably, the at least one antenna is configured to sense the foreign body capacitively, in particular on the basis of a change in capacitance, brought about by the foreign body, of the electric and/or magnetic field. Alternatively or additionally, it is conceivable for the at least one antenna to be configured to sense the foreign body inductively, in particular on the basis of a change in inductance, brought about by the foreign body, of the electric and/or magnetic field.

Preferably, in particular in at least one exemplary embodiment, the sensor unit may comprise a tuning circuit that is connected to the antenna. The tuning circuit is intended in particular at least to generate an electric and/or magnetic field through interaction with the antenna. The tuning circuit is preferably formed at least from a resonant circuit, in particular an RLC resonant circuit, and a phase stabilization circuit. Preferably, an operating frequency of the tuning circuit is less than 5 MHz. Alternatively, it is also conceivable, however, for the operating frequency of the tuning circuit to be greater than 5 MHz. The tuning circuit has in particular at least one amplifier, which is formed for example by a field effect transistor, a bipolar transistor, an operational amplifier or the like. Furthermore, various amplifier topologies are conceivable, for example a telescopic topology, a two-stage amplifier topology, a cascode topology or the like. The tuning circuit is preferably connected to a signal processing unit, in particular an analog-digital converter, wherein the signal processing unit is connectable, for signal transmission, at least to the open-loop and/or closed-loop control unit. The signal processing unit comprises preferably at least one comparator, in particular a Schmitt trigger, which is usable for converting an analog signal, preferably from the antenna, into a digital signal.

The configuration according to the invention of the power tool device can advantageously allow reliable sensing of at least one foreign object in a detection area. Advantageously, the foreign object can be sensed preventively, in particular prior to contact with a machining tool. Advantageously, enough time for carrying out at least one action can be provided by the sensing. Advantageously, a risk of injury for a user can be kept low. Advantageously, it is possible to dispense with high-speed reaction systems that are expensive, complex and/or damage the machining tool. Advantageously, a machine tool device that is safe and comfortable for the user and exhibits low wear can be provided.

Furthermore, it is proposed that the sensor unit comprises at least one field shielding element which is formed in particular integrally with the antenna and is configured to shield an electric and/or magnetic field, emitted by the antenna, in at least one emission direction. Preferably, the field shielding element encloses the antenna at least partially. The field shielding element is formed in particular from a material that is not transparent to electromagnetic radiation, preferably to electric and/or magnetic fields, in particular from a metal, for example from a lead, from an iron, from a steel or the like. It is also conceivable for the antenna to be formed at least partially by a coaxial cable, wherein the coaxial cable forms the field shielding element. In particular, the field shielding element is intended to absorb and/or reflect the electric and/or magnetic field of the at least one antenna in the at least one emission direction. In addition, it is conceivable for the field shielding element to be configured to focus the electric and/or magnetic field of the at least one antenna in at least one emission direction without shielding. In particular, the at least one antenna is arranged without shielding as seen in at least one emission direction. In particular, at least one risk area of the machining tool, for example a cutting edge of the machining tool, is arranged in the at least one emission direction, as seen in which the at least one antenna is arranged without shielding. Advantageously, an orientation of the electric and/or magnetic field of the at least one antenna can be allowed. Advantageously, an electric and/or magnetic field can be directed toward a desired area in which foreign bodies are intended to be sensed.

Furthermore, it is proposed that the sensor unit, in particular in at least one exemplary embodiment, comprises at least one electrical or electronic shielding circuit which is configured to shield an electric and/or magnetic field, emitted by the antenna, in at least one emission direction. By means of the shielding circuit, in particular an emission direction of the antenna is settable. The shielding circuit is preferably in the form of a high-impedance circuit. The shielding circuit comprises preferably at least one high-impedance electrical component. In particular, the antenna and/or the tuning circuit of the sensor unit is/are connected to an input of the shielding circuit. Preferably, at least one output of the shielding circuit is grounded. Preferably, the shielding circuit has a higher impedance at the input of the shielding circuit than at the output of the shielding circuit. For example, the impedance at the input of the shielding circuit is in the order of magnitude of 100 MΩ and the impedance at the output of the shielding circuit is in the order of magnitude of 10 MΩ or less. Thus, it is advantageously possible for the field lines of the electric and/or magnetic field to be emitted at least substantially in an emission direction from the antenna. However, it is also conceivable in principle for the orders of magnitude to be different from the values mentioned above at the input and output. Advantageously, an orientation of the electric and/or magnetic field of the at least one antenna can be allowed. Advantageously, an electric and/or magnetic field can be directed at a desired area in which foreign bodies are intended to be sensed. Advantageously, an orientation of the electric and/or magnetic field can be adapted particularly easily.

Furthermore, it is proposed that the open-loop and/or closed-loop control unit is configured to determine at least one movement characteristic of the at least one foreign body and/or at least one distance of the at least one foreign body from the machining tool on the basis of the at least one signal from the sensor unit. Preferably, the open-loop and/or closed-loop control unit is configured to trigger the at least one action on the basis of the at least one determined movement characteristic of the at least one foreign body and/or on the basis of the at least one determined distance of the at least one foreign body from the machining tool. In particular, the open-loop and/or closed-loop control unit is configured to evaluate the at least one determined movement characteristic of the at least one foreign body and/or the at least one determined distance of the at least one foreign body from the machining tool and to trigger the at least one action in particular on the basis of a result of the evaluation. The at least one movement characteristic of the foreign body is preferably in the form of a speed of movement of the foreign body, in particular of a speed at which the foreign body approaches the machining tool, of an acceleration of movement of the foreign body, in particular of an acceleration with which the foreign body approaches the machining tool, of a direction of movement of the foreign body or of some other movement characteristic that appears to make sense to a person skilled in the art. In particular, the open-loop and/or closed-loop control unit is configured to determine the distance of the foreign body from the machining tool, in particular a position of the foreign body at least relative to the machining tool, on the basis of the at least one signal from the sensor unit. Preferably, the open-loop and/or closed-loop control unit is configured to determine the at least one movement characteristic of the foreign body on the basis of a plurality of signals from the sensor unit, in particular signals that are sensed with a time offset. In particular, the open-loop and/or closed-loop control unit is configured to determine the speed of movement of the foreign body, in particular the speed at which the foreign body approaches the machining tool, on the basis of a period of time that has passed between two operations of sensing and/or determining the foreign body at two different distances from the machining tool, in particular at two different positions, and on the basis of a spatial difference between the two different distances from the machining tool, in particular between the two different positions. Preferably, the open-loop and/or closed-loop control unit is configured to determine the acceleration of movement of the foreign body, in particular the acceleration with which the foreign body approaches the machining tool, on the basis of different determined speeds of movement of the foreign body at different distances from the machining tool, in particular at different positions.

Preferably, the open-loop and/or closed-loop control unit is configured to determine the distance of the foreign body from the machining tool, in particular the position of the foreign body at least relative to the machining tool, on the basis of a signal strength of the signal sensed by the sensor unit, in particular on the basis of a level in the change of the electric and/or magnetic field of the at least one antenna. Alternatively or additionally, it is conceivable for the sensor unit to be configured to provide a plurality of detection areas with different radii around the machining tool, wherein the open-loop and/or closed-loop control unit is configured in particular to determine the distance of the foreign body from the machining tool, in particular the position of the foreign body, on the basis of the foreign body being sensed in a particular detection area. Preferably, the at least one antenna is configured to provide the plurality of detection areas with different radii around the machining tool. Alternatively or additionally, it is conceivable for the sensor unit to comprise a plurality of antennas, in particular a number of antennas corresponding to a number of detection areas to be provided, wherein in particular in each case one antenna is configured to provide at least one of the plurality of detection areas. A “radius of a detection area around the machining tool” should be understood in particular as meaning a maximum extent of the detection area from the machining tool, at which the sensor unit is still configured to sense the foreign body. Preferably, the detection areas are in the form of layers or shells, in particular cylindrical shells, spherical shells or the like. In particular, the detection areas have equidistant extents between one another as seen along the radii of the detection areas. Alternatively, it is conceivable for the detection areas to have different extents between one another as seen along the radii of the detection areas. Advantageously, user safety of the power tool device can be increased by particularly precise sensing and tracking of the foreign body.

Furthermore, it is proposed that the open-loop and/or closed-loop control unit is configured to trigger different actions on the basis of different determined movement characteristics of the at least one foreign body and/or on the basis of different determined distances of the at least one foreign body from the machining tool. In particular, a plurality of different movement characteristics of the at least one foreign body and/or of different distances of the at least one foreign body from the machining tool and a plurality of actions to be triggered that are associated with the different movement characteristics and/or the different distances of the foreign body can be stored in the memory unit of the open-loop and/or closed-loop control unit. Preferably, the open-loop and/or closed-loop control unit is configured to compare the determined movement characteristic of the foreign body and/or the determined distance of the foreign body with the movement characteristics and/or distances of the foreign body that are stored in the memory unit. In particular, the open-loop and/or closed-loop control unit is configured to trigger the at least one action associated with the determined movement characteristic and/or the determined distance of the foreign body on the basis of the comparison.

For example, it is conceivable for the open-loop and/or closed-loop control unit to be configured to trigger an output of a warning signal on the basis of a determined first speed of movement of the foreign body and/or on the basis of a determined first distance of the foreign body from the machining tool. For example, it is conceivable for the open-loop and/or closed-loop control unit to be configured to trigger a reduction in rotational speed of a motor driving the machining tool on the basis of a determined second speed of movement of the foreign body that is faster than the first speed of movement of the foreign body and/or on the basis of a determined second distance of the foreign body from the machining tool that is less than the determined first distance of the foreign body from the machining tool. For example, it is conceivable for the open-loop and/or closed-loop control unit to be configured to trigger braking of the motor driving the machining tool and/or of the machining tool on the basis of a determined third speed of movement of the foreign body that is faster than the second speed of movement of the foreign body and/or on the basis of a determined third distance of the foreign body from the machining tool that is less than the determined second distance of the foreign body from the machining tool. Advantageously, high user comfort and high user safety can be achieved by matching actions to different movement characteristics of the foreign body and/or distances of the foreign body from the machining tool.

Furthermore, it is proposed that the open-loop and/or closed-loop control unit is configured to determine a probability of contact of the at least one foreign body with the moving machining tool on the basis of the at least one movement characteristic of the at least one foreign body and/or of the at least one distance of the at least one foreign body from the machining tool and on the basis of a minimum time for braking the machining tool to a standstill. In particular, the open-loop and/or closed-loop control unit is configured to evaluate the at least one movement characteristic of the at least one foreign body and/or the at least one distance of the at least one foreign body from the machining tool and the minimum time for braking the machining tool to a standstill in order to determine the probability of contact of the at least one foreign body with the moving machining tool. A “minimum time for braking the machining tool to a standstill” should be understood in particular as meaning a shortest period of time in which the machining tool is able to be braked from operation, in particular from movement, to a standstill.

In particular, the open-loop and/or closed-loop control unit is configured to determine the minimum time for braking the machining tool to a standstill, in particular on the basis of characteristics of the machining tool, for example an inertia of the machining tool, a rotational speed of the machining tool, a speed of movement of the machining tool or the like, and on the basis of available braking possibilities for braking the machining tool to a standstill, for example a maximum braking force of a brake unit of the power tool device, a minimum activation duration of the brake unit, a minimum time until engagement of the brake unit or the like. In particular, the power tool device can have at least one sensing unit which is configured to sense the characteristics of the machining tool and the available braking possibilities and to provide them to the open-loop and/or closed-loop control unit. Alternatively or additionally, it is conceivable for the maximum time for braking the machining tool to a standstill and/or at least the characteristics of the machining tool and/or the available braking possibilities to be stored in the memory unit of the open-loop and/or closed-loop control unit. Preferably, the open-loop and/or closed-loop control unit is configured to trigger the at least one action on the basis of the determined probability of contact of the foreign body with the moving machining tool, in particular on the basis of an evaluation of the determined probability of contact of the foreign body with the moving machining tool. Advantageously, a further parameter for increasing user safety can be determined.

Furthermore, it is proposed that the open-loop and/or closed-loop control unit is configured to trigger a different action on the basis of the probability of contact being below a probability threshold value than on the basis of the probability of contact being above the probability threshold value. The probability threshold value is preferably stored in the memory unit of the open-loop and/or closed-loop control unit. In particular, the probability threshold value is in the form of a value of a probability of contact of the at least one foreign body with the moving machining tool of between 0% and 100%, for example 10%.

Preferably, the open-loop and/or closed-loop control unit is configured to compare the determined probability of contact with the probability threshold value and to trigger the at least one action on the basis of the comparison. For example, it is conceivable for the open-loop and/or closed-loop control unit to be configured to trigger braking of the machining tool on the basis of the probability of contact being below the probability threshold value and to additionally trigger the making of an emergency call on the basis of the probability of contact being above the probability threshold value. For example, it is conceivable for the open-loop and/or closed-loop control unit to be configured to trigger a movement of movable teeth of the machining tool, for example of a hedge trimmer, into a closed position, in particular to prevent the user being injured on the stationary but sharp-edged teeth, on the basis of the probability of contact being below the probability threshold value. For example, it is conceivable for the open-loop and/or closed-loop control unit to be configured to trigger a movement of the movable teeth of the machining tool into an opened position, in particular to prevent a body part of the user being severed by the teeth moving into the closed position on contact with the machining tool, on the basis of the probability of contact being above the probability threshold value. Advantageously, optimization of user safety can be allowed.

Furthermore, it is proposed that the open-loop and/or closed-loop control device is configured to classify different foreign bodies sensed by the sensor unit and to trigger different actions on the basis of different classifications. In particular, the open-loop and/or closed-loop control unit is configured to distinguish between different types of foreign bodies on the basis of different signals from the sensor unit. In particular, different types of foreign bodies have different electrical and/or magnetic, in particular capacitive, properties, and in particular influence the electric and/or magnetic field of the at least one antenna differently. In particular, each type of foreign body has its own electrical and/or magnetic, in particular capacitive, signature. Preferably, the open-loop and/or closed-loop control unit is configured to identify a type of the foreign body on the basis of the electrical and/or magnetic, in particular capacitive, signature of the foreign body and to classify the foreign body. Preferably, electrical and/or magnetic, in particular capacitive, signatures of different types of foreign bodies are stored in the memory unit of the open-loop and/or closed-loop control unit. In particular, the open-loop and/or closed-loop control unit is configured to compare a signal from the sensor unit corresponding to the sensing of a foreign body with the stored signatures and to classify the foreign body on the basis of the comparison. In particular, the open-loop and/or closed-loop control unit is configured to distinguish between living and inanimate foreign bodies on the basis of different signals from the sensor unit and to accordingly classify the foreign bodies. Preferably, the open-loop and/or closed-loop control unit is configured to distinguish between human and animal living foreign bodies on the basis of different signals from the sensor unit and to accordingly classify the foreign bodies. Preferably, the open-loop and/or closed-loop control unit is configured to distinguish between inanimate foreign bodies of different material on the basis of different signals from the sensor unit and to accordingly classify the foreign bodies. Preferably, different actions to be triggered that are associated with different classifications of foreign bodies are stored in the memory unit of the open-loop and/or closed-loop control unit. In particular, the open-loop and/or closed-loop control unit is configured to trigger at least one action associated with a classification of a sensed foreign body. For example, it is conceivable for the open-loop and/or closed-loop control unit to be configured to trigger pivoting of the machining tool away from a risk area on the basis of a sensed foreign body being classified as an inanimate foreign body and to trigger mechanical braking of the machining tool on the basis of a sensed foreign body being classified as a living foreign body. Advantageously, triggering of an action specific to a foreign body can be allowed.

Furthermore, it is proposed that the open-loop and/or closed-loop control unit is configured to trigger the at least one action on the basis of at least one parameter, in particular on the basis of at least one dimension, of the machining tool. Preferably, the dimension of the machining tool is in the form of a maximum main extent of the machining tool. A “main extent” of an object should be understood in particular as meaning an extent of the object in a main extension direction of the object. A “main extension direction” of an object should be understood in particular as being a direction which extends parallel to a longest edge of a smallest geometric cuboid that still just entirely encloses the object. The term “parallel” should be understood in particular as being an orientation of a direction relative to a reference direction, in particular in a plane, wherein the direction has a deviation in particular of less than 8°, advantageously less than 5° and particularly advantageously less than 2° with respect to the reference direction.

In particular, the open-loop and/or closed-loop control unit can be configured to prevent the at least one action on the basis of the at least one parameter, in particular on the basis of the at least one dimension, of the machining tool. Preferably, the open-loop and/or closed-loop control unit is configured to trigger the at least one action on the basis of the at least one dimension, in particular on the basis of the maximum main extent, of a machining tool in the form of a nail. In particular, the open-loop and/or closed-loop control unit is configured to control at least one dispensing unit of the power tool device, which is intended to dispense the machining tool in the form of a nail, on the basis of the at least one dimension, in particular on the basis of the maximum main extent, of the machining tool in the form of a nail. In particular, it is conceivable for the open-loop and/or closed-loop control unit to be configured to trigger dispensing of the machining tool in the form of a nail on the basis of the dimension, in particular the maximum main extent, of the machining tool in the form of a nail being smaller than a determined distance between the sensed foreign body and the machining tool. In particular, it is conceivable for the open-loop and/or closed-loop control unit to be configured to prevent dispensing of the machining tool in the form of a nail on the basis of the dimension, in particular the maximum main extent, of the machining tool in the form of a nail being greater than a determined distance between the sensed foreign body and the machining tool.

Preferably, the open-loop and/or closed-loop control unit is configured to trigger the at least one action on the basis of at least one further parameter, for example a dispensing energy of the dispensing unit, a material hardness of the workpiece, a thickness of the workpiece or the like. Alternatively or additionally to being in the form of a dimension of the machining tool, the at least one parameter of the machining tool can also be in the form of a penetration depth of the machining tool in the workpiece, of an inertia characteristic of the machining tool, of a rotational speed of the machining tool or of some other parameter that appears to make sense to a person skilled in the art. Advantageously, a hazardous situation can be prevented early and user safety increased further.

Furthermore, it is proposed that the power tool device has at least one further sensor unit, which has at least one contact sensor element, arranged in the vicinity, in the form of a guide region, of the machining tool, for sensing at least one body part of a user. Preferably, a power tool in the form of a milling machine, in particular of a router or of a trimmer, of a saw, in particular of a chain saw, or of a hedge trimmer, comprises the power tool device that has the at least one guide region. Preferably, the guide region is formed at least partially by a base unit of the power tool device, in particular by a guide element of the base unit, for example a sliding shoe or a handle. Preferably, the machining tool, in particular the output shaft, extends at least partially through the guide element, formed in particular as a sliding shoe. In particular, the power tool device is guidable along the workpiece by means of the guide element. In particular, the guide element, formed in particular as a sliding shoe, is intended to bear on the workpiece. Preferably, the guide element is intended to be grasped, in particular in the guide region, by the user, in particular to effect controlled guidance of the power tool device. The “vicinity” of an object should be understood as being in particular a region that is arranged at a maximum distance of at most 20 cm, preferably at a maximum distance of at most 10 cm, particularly preferably at a maximum distance of at most 5 cm and very particularly preferably at a maximum distance of at most 1 cm from the object. Preferably, the at least one contact sensor element is arranged on the guide element, in particular integrated in the guide element with a precise fit.

Preferably, the contact sensor element is in the form of a capacitive sensor, of a pressure-sensitive sensor, of a fingerprint scanner, of a conductivity sensor, or of some other contact sensor element that appears to make sense to a person skilled in the art. Preferably, the further sensor unit is connected to the open-loop and/or closed-loop control unit for signal transmission purposes, in particular via a signal line and/or a wireless connection. In particular, the further sensor unit is configured to provide at least one signal to the open-loop and/or closed-loop control unit on the basis of sensing of the at least one body part, in particular at least one finger, of the user. Preferably, the open-loop and/or closed-loop control unit is configured to trigger the at least one action on the basis of the at least one signal from the further sensor unit, in particular on the basis of sensing of the at least one body part in the guide region. For example, it is conceivable for the open-loop and/or closed-loop control unit to be designed to activate the motor that drives the machining tool on the basis of sensing of the body part. For example, it is conceivable for the open-loop and/or closed-loop control unit to be configured to deactivate the motor that drives the machining tool on the basis of a lack of sensing of the body part, in particular to prevent uncontrolled guidance of the power tool device. Advantageously, correct operation of the power tool device can be allowed and a high level of user safety achieved.

Furthermore, it is proposed that the open-loop and/or closed-loop control unit is configured to adapt at least one parameter, in particular the at least one detection area, at least partially autonomously on the basis of at least one signal from the further sensor unit. Preferably, the open-loop and/or closed-loop control unit is configured to adapt the at least one parameter entirely autonomously, in particular automatically, on the basis of the at least one signal from the further sensor unit. Alternatively, it is conceivable for the open-loop and/or closed-loop control unit to be configured to adapt the at least one parameter partially autonomously. In particular, the open-loop and/or closed-loop control unit can be configured to provide the user, on the basis of the at least one signal from the further sensor unit, in particular on the basis of the evaluation of the at least one signal from the further sensor unit, with at least one recommendation for adaptation of the at least one parameter, for example via a signal output unit of the power tool device, and to adapt the at least one parameter on the basis of a user input. In particular, the open-loop and/or closed-loop control unit can be configured to adapt a plurality of parameters at least partially autonomously on the basis of the at least one signal from the further sensor unit. The at least one parameter to be adapted can in particular be in the form of a sensitivity of the sensor unit, of the detection area, in particular of the extent of the detection area, of the shape of the detection area or the like, of a type of the at least one action to be triggered, of a sequence of a number of actions to be triggered, of a triggering speed and/or of a speed at which the at least one action is carried out, for example a braking speed of the machining tool, or of some other parameter that appears to make sense to a person skilled in the art.

Preferably, the open-loop and/or closed-loop control unit is configured to adapt the detection area, in particular the extent of the detection area, in particular to make it larger or smaller, at least partially autonomously on the basis of the at least one signal from the further sensor unit. In particular, the open-loop and/or closed-loop control unit is configured, on the basis of a signal from the further sensor unit corresponding to sensing of the at least one body part in the guide region, to at least partially autonomously set the detection area, in particular a maximum extent of the detection area, to be smaller than a minimum distance between the machining tool and the guide region, in particular to avoid erroneous triggering by the body part. In particular, the open-loop and/or closed-loop control unit is configured, on the basis of a signal from the further sensor unit corresponding to a lack of sensing of the at least one body part in the guide region, to at least partially autonomously set the detection region, in particular a maximum extent of the detection region, to be larger than a minimum distance between the machining tool and the guide region, in particular to reduce a risk of injury as a result of incorrect operation of the power tool device. Advantageously, a power tool device that is safe for the user and has a low erroneous triggering rate can be provided.

In addition, it is proposed that the at least one antenna is arranged in the form of a ring about a longitudinal axis of the machining tool. Preferably, a power tool in the form of a router, of a trimmer, of a jigsaw or of a reciprocating saw comprises the power tool device having the at least one antenna that is arranged in the form of a ring about the longitudinal axis of the machining tool. Preferably, the at least one antenna is arranged in a plane that extends transversely, in particular perpendicularly to the longitudinal axis of the machining tool. Preferably, the at least one antenna is arranged in the form of a circular ring, of a part ring, in particular of a half ring, or the like, about the longitudinal axis of the machining tool. Preferably, the at least one antenna is arranged on the base unit of the power tool device, in particular on the guide element in particular in the form of a sliding shoe. In particular, the at least one antenna can be arranged at least partially within the base unit, in particular within the guide element. Preferably, the sensor unit can have a plurality of antennas, wherein in particular two antennas can be arranged on sides of the guide element that face away from one another. Preferably, the at least one antenna is arranged in at least one plane that extends parallel to a sliding face of the guide element in particular in the form of a sliding shoe. Advantageously, uniform sensor coverage of the machining tool and a direction-independently high level of user safety can be achieved.

Furthermore, it is proposed that the at least one antenna is arranged parallel to a longitudinal axis of the machining tool. In particular, the at least one antenna, alternatively or additionally to being arranged in the form of a ring about the longitudinal axis of the machining tool, is arranged parallel to the longitudinal axis of the machining tool. In particular, the sensor unit can have at least two antennas, wherein one antenna is arranged in the form of a ring about the longitudinal axis of the machining tool and a further antenna is arranged parallel to the longitudinal axis of the machining tool. Preferably, a power tool in the form of a hedge trimmer, of a chain saw, of a router, of a trimmer, of a jigsaw or of a reciprocating saw comprises the power tool device having the at least one antenna that is arranged parallel to the longitudinal axis of the machining tool. In particular, the machining tool can at least partially form the at least one antenna and/or the at least one antenna can be arranged at least partially on, in particular within, the machining tool. Alternatively or additionally, it is conceivable for at least one guide bar element of the power tool device, on which the machining tool is at least partially mounted, to at least partially form the at least one antenna, and/or for the at least one antenna to be arranged at least partially on, in particular within, the guide bar element. Preferably, the at least one antenna extends linearly. Advantageously, a further possibility for uniform sensor coverage of the machining tool and direction-independently high user safety can be achieved.

Furthermore, it is proposed that the at least one antenna is integrated in at least one mechanical protective element in the vicinity, in particular the abovementioned vicinity, of the machining tool, and/or that the at least one antenna is configured to replace the mechanical protective element. Preferably, the power tool device has the mechanical protective element for protecting the machining tool, in particular from foreign bodies, and/or for protecting foreign bodies, in particular body parts of the user, from the machining tool. The mechanical protective element is arranged in particular in the vicinity of the machining tool. Preferably, the mechanical protective element covers the machining tool at least partially, and in particular encloses the machining tool at least partially. Preferably, the mechanical protective element is in the form of a guard bracket, of a protective hood or of some other mechanical protective element that appears to make sense to a person skilled in the art. In particular, the mechanical protective element can at least partially form the at least one antenna, in particular be formed from a metal, and/or the at least one antenna can be arranged at least partially on, in particular within, the mechanical protective element. Alternatively, it is conceivable for the at least one antenna to be configured to replace the mechanical protective element, in particular a protective function of the mechanical protective element. In particular, the at least one antenna is configured to provide virtual shielding of the machining tool, in particular in the form of the detection area. In particular, as an alternative to mechanical protection by the mechanical protective element, in order to reduce a risk of injury by the machining tool and/or a risk of damage to the machining tool, the at least one action, in particular braking of the machining tool, moving the machining tool away from the risk area, mechanical shielding of the machining tool or the like is able to be triggered on the basis of sensing of the foreign body by the at least one antenna. In particular, the power tool device can be formed free of the mechanical protective element. Advantageously, a power tool device that is safe for the user, uses few components and thus advantageously exhibits low wear can be provided.

Furthermore, it is proposed that the power tool device comprises at least one housing from which the sensor unit is able to be uncoupled, wherein the sensor unit has at least one, in particular wireless, communications unit for providing the at least one signal to the open-loop and/or closed-loop control unit. In particular, the power tool device can be operable in a state uncoupled from the sensor unit, in particular in a state free from a connection for signal transmission purposes between the sensor unit and the open-loop and/or closed-loop control unit, in particular free of comfort functions and safety functions based on the sensor unit. Preferably, the sensor unit is able to be used with, in particular able to be coupled to, different power tool devices. Preferably, the housing of the power tool device and the sensor unit, in particular a housing of the sensor unit, can have coupling interfaces, for example bayonet connections, latching elements, plugs or the like, for mechanical, in particular mechanical and electrical, coupling. In particular, an electrical coupling interface can at least partially form the communications unit of the sensor unit and/or a communications unit of the power tool device. In particular, the communications unit of the sensor unit is configured to transmit the at least one signal to the open-loop and/or closed-loop control unit via the communications unit of the power tool device. The communications unit, in the form of a wireless communications unit, of the sensor unit and/or of the power tool device can in particular be in the form of a WLAN module, of a radio module, of a Bluetooth module, of an NFC module or the like. The communications unit, in the form of a wired communications unit, of the sensor unit and/or of the power tool device can, alternatively or additionally to being formed by the at least one coupling interface, be in particular in the form of a USB connection, of an Ethernet connection, of a coaxial connection or the like. Advantageously, a sensor unit that is usable in a modular manner for user convenience, in particular with different power tool devices, can be provided.

In addition, it is proposed that the power tool device comprises at least one dispensing unit, in particular the abovementioned dispensing unit, for dispensing the at least one machining tool, wherein the open-loop and/or closed-loop control unit is configured to control the dispensing unit to prevent or to enable the dispensing of the at least one machining tool on the basis of the at least one signal from the sensor unit. Preferably, the dispensing unit is intended to dispense the machining tool in the form of a nail. In particular, the dispensing unit is intended to shoot the machining tool. In particular, the dispensing unit is intended to dispense, in particular shoot, a plurality of machining tools one after another. In particular, a power tool in the form of a nail gun comprises the power tool device that comprises the dispensing unit. In particular, the power tool device can comprise at least one magazine unit, which is intended to receive a plurality of machining tools and/or to feed the plurality of machining tools to the dispensing unit.

Preferably, the open-loop and/or closed-loop control unit is configured to control the dispensing unit to prevent the dispensing of the machining tool on the basis of at least one signal from the sensor unit corresponding to sensing of at least one foreign body in the detection area, in particular in a dispensing area of the dispensing unit. In particular, it is conceivable for the open-loop and/or closed-loop control unit to additionally be configured to trigger an output of a warning signal on the basis of the signal from the sensor unit corresponding to the sensing of the foreign body in the detection area, in particular in the dispensing area of the dispensing unit. Preferably, the open-loop and/or closed-loop control unit is configured to control the dispensing unit to release the machining tool on the basis of at least one signal from the sensor unit corresponding to a lack of sensing of a foreign body in the detection area, in particular in the dispensing area of the dispensing unit. In particular, the open-loop and/or closed-loop control unit can be configured to compare a determined position of a sensed foreign body with the dispensing area of the dispensing unit and to control the dispensing unit in particular on the basis of the comparison. In particular, the open-loop and/or closed-loop control unit can be configured to control the dispensing unit to release the machining tool on the basis of at least one signal from the sensor unit corresponding to sensing of at least one foreign body in the detection area and on the basis of a determined position of the foreign body outside the dispensing area of the dispensing unit. Advantageously, dispensing of machining tools in a manner that is safe for the user can be allowed.

Furthermore, it is proposed that the power tool device comprises at least one mechanical brake unit that is controllable by the open-loop and/or closed-loop control unit, is intended to brake the machining tool and is at least partially in the form of at least one self-locking gear, in particular of a worm gear. Preferably, the mechanical brake unit is intended to mechanically brake the at least one, in particular moving, machining tool, in particular until the machining tool is at a standstill. In particular, the mechanical brake unit, in particular in addition to being at least partially formed by the self-locking gear, may comprise at least one mechanical brake element, in particular a brake shoe, a wrap spring, a blocking pin or the like, which, to effect active braking of the machining tool, is able to be coupled by a force- and/or form-fit to the machining tool and/or to the output shaft. Preferably, the mechanical brake unit is intended to brake the machining tool at most 200 milliseconds after triggering of the mechanical braking, until the machining tool is at a standstill.

Preferably a power tool in the form of garden shears comprises the power tool device that comprises the mechanical brake unit which is formed at least partially by the at least one self-locking gear, in particular by the worm gear. Preferably, the gear is intended to transform a movement of the motor into a drive for the at least one machining tool. Preferably, the gear and the motor are provided for motor support of manual actuation of the at least one machining tool, in particular a cutting movement of the garden shears. Preferably, the gear has a transmission ratio, in particular of a speed of the motor to a speed of the machining tool, of at least 1:50, preferably of at least 1:75 and particularly preferably of at least 1:100. Preferably, the gear is able to be driven via a driveshaft of the motor. Preferably, the gear is not able to be driven via the output shaft, on which the machining tool is mounted. Preferably, the gear is in the form of a dynamically self-locking gear. In particular, the gear is in the form of a worm gear which has a maximum degree of efficiency of less than 0.5. Preferably, the gear is intended to stop a movement of the at least one machining tool on the basis of a stopping of the motor. In particular, the open-loop and/or closed-loop control unit is configured to effect and/or trigger motor braking of the motor on the basis of at least one signal from the sensor unit. In particular, the open-loop and/or closed-loop control unit is configured to switch off, to short-circuit, to reverse the polarity of or similarly act on the motor, in particular electric motor, driving the machining tool, in order to effect motor braking. Advantageously, efficient braking of the at least one machining tool that exhibits low wear and is safe for the user can be allowed.

Furthermore, it is proposed that the power tool device comprises at least one protective unit which has at least one shielding element, wherein the open-loop and/or closed-loop control unit is configured to control the protective unit to move the at least one shielding element around the machining tool on the basis of the at least one signal from the sensor unit. In particular, the power tool device has the protective unit as an alternative or in addition to the mechanical brake unit. Preferably, the shielding element is intended to at least partially cover, in particular to enclose, the machining tool. In particular, the shielding element is intended to cover, in particular to enclose, at least one risk area, in particular at least one cutting edge, of the machining tool. Preferably, the shielding element is intended to protect a foreign body, in particular a body part of the user, from the machining tool and/or the machining tool from a foreign body. In particular, the shielding element is intended to prevent the machining tool from being grasped, in particular by the user. The shielding element can in particular be in the form of a shielding hood, of a shielding cover, of an airbag, of a cage or of some other shielding element that appears to make sense to a person skilled in the art. In particular, the shielding element is mounted movably on, in particular at least partially within, the base unit of the power tool device. In particular, the shielding element can be formed in a telescopic, inflatable, clampable or similar manner. Preferably, the protective unit comprises at least one actuator, which is intended to move the shielding element around the machining tool and/or to enable the shielding element to be moved by at least one further actuator of the protective unit. In particular, the open-loop and/or closed-loop control unit is configured to control the actuator to move the shielding element around the machining tool on the basis of the at least one signal from the sensor unit. The at least one actuator can in particular be in the form of an electromagnetic actuator, of a spring force actuator, of a compressed-air actuator, of an explosive actuator, of a fuse wire actuator, of a shape memory actuator or of some other actuator that appears to make sense to a person skilled in the art. Advantageously, a high level of user safety free from damage to the machining tool can be allowed.

Furthermore, it is proposed that the power tool device comprises at least one retraction unit, wherein the open-loop and/or closed-loop control unit is configured to control the retraction unit to move the machining tool out of a machining area on the basis of the at least one signal from the sensor unit. In particular, the power tool device has the retraction unit as an alternative or in addition to the mechanical brake unit and/or to the protective unit. The machining area is in particular an area within the detection area. In particular, the machining area can correspond to the detection area. In particular, at least the machining tool and at least the workpiece are arranged at least partially in the machining area. In particular, in the machining area, there is a risk of injury for the user by touching the machining tool and/or a risk of damage for the machining tool by touching a foreign body. The retraction unit is preferably intended to pull, in particular to retract, to push, to drive or pivot the machining tool out of the machining area or to move it out of the machining area in some other way that appears to make sense to a person skilled in the art. Preferably, the retraction unit is intended to move the machining tool away from a sensed foreign body. In particular, the retraction unit is intended to move the machining tool at least partially into an at least partially covered area of the power tool device, for example into the base unit, into the protective hood or the like.

Preferably, the retraction unit comprises at least one actuator, which is intended to move the machining tool out of the machining area. The actuator is preferably operatively connected to the machining tool, in particular directly, for example mechanically, magnetically or the like, and/or indirectly, for example via a pivot arm, the output shaft or the like. Preferably, the machining tool and/or at least one component on which the machining tool is mounted, for example the output shaft, the pivot arm or the like, is/are mounted movably, in particular so as to be movable out of the machining area. In particular, the open-loop and/or closed-loop control unit is configured to control the actuator to move the machining tool out of the machining area on the basis of the at least one signal from the sensor unit. The at least one actuator can in particular be in the form of an electromagnetic actuator, of a spring force actuator, of a compressed-air actuator, of an explosive actuator, of a fuse wire actuator, of a shape memory actuator or of some other actuator that appears to make sense to a person skilled in the art. In particular, the actuator and/or the open-loop and/or closed-loop control unit can be intended to use brake energy of braking of the machining tool and/or at least one electric current from motor braking of the motor driving the machining tool to move the machining tool. The actuator can in particular be intended to uncouple the machining tool and/or the output shaft from the motor driving the machining tool in order to move the machining tool out of the machining area. In particular, the retraction unit can have ramp elements along which the machining tool and/or the output shaft can slide out of the machining area on the basis of motion energy, in particular rotational energy, of the machining tool and/or of the output shaft. Advantageously, a further possibility can be provided of allowing a high level of user safety free of damage to the machining tool.

The invention is also based on a method for operating a power tool device, in particular a power tool device according to the invention.

It is proposed that, in at least one method step, by means of at least one antenna, in particular the at least one abovementioned antenna, at least one electric and/or magnetic field is emitted, said field defining at least one detection area about at least one machining tool, in particular about the abovementioned machining tool, of the power tool device, and/or that, by means of the at least one antenna, at least one foreign body is sensed on the basis of at least one change in at least one electric and/or magnetic field.

Preferably, in at least one method step, at least one movement characteristic of the at least one foreign body and/or at least one distance of the at least one foreign body from the machining tool is/are determined on the basis of at least one signal from at least one sensor unit, in particular the abovementioned sensor unit, of the power tool device. Advantageously, a method can be provided, by means of which low-maintenance operation of a power tool device, which is safe and comfortable for a user, can be allowed.

Furthermore, the invention is based on a power tool according to the invention having at least one power tool device. Advantageously, a low-wear power tool can be provided, which is usable in a manner that is safe and comfortable for a user.

The power tool device according to the invention, the power tool according to the invention and/or the method according to the invention is/are not intended to be limited to the above-described application and embodiment. In particular, the power tool device according to the invention, the power tool according to the invention and/or the method according to the invention can have a number of individual elements, components and units, and method steps, that differs from a number mentioned herein in order to fulfill a mode of operation described herein. In addition, for the ranges of values specified in this disclosure, values that lie within the mentioned limits are also intended to be considered to be usable as desired and disclosed.

### DRAWINGS

Further advantages will become apparent from the following description of the drawings. In the drawings, ten exemplary embodiments of the invention are illustrated. The drawings, the description and the claims contain numerous features in combination. A person skilled in the art will expediently also consider the features individually and combine them to form useful further combinations.

In the drawings:

FIG. 1 shows a schematic perspective illustration of a power tool according to the invention,

FIG. 2a shows the power tool according to the invention from FIG. 1 in a schematic illustration,

FIG. 2b shows the power tool according to the invention from FIG. 1 with an alternative sensor unit in a schematic illustration,

FIG. 2c shows the power tool according to the invention from FIG. 1 with a further alternative sensor unit in a schematic illustration,

FIG. 3 shows a sectional view of a part of the power tool according to the invention in a schematic illustration,

FIG. 4 shows a first alternative power tool according to the invention in a schematic perspective illustration,

FIG. 5 shows a circuit arrangement of a part of a sensor unit of a power tool device according to the invention of the first alternative power tool according to the invention,

FIG. 6 shows a second alternative power tool according to the invention in a schematic perspective illustration,

FIG. 7 shows a third alternative power tool according to the invention in a schematic perspective illustration,

FIG. 8 shows a fourth alternative power tool according to the invention in a schematic perspective illustration,

FIG. 9 shows a fifth alternative power tool according to the invention in a schematic perspective illustration,

FIG. 10 shows a sixth alternative power tool according to the invention in a schematic perspective illustration,

FIG. 11 shows a seventh alternative power tool according to the invention in a schematic perspective illustration,

FIG. 12 shows an eighth alternative power tool according to the invention in a schematic perspective illustration, and

FIG. 13 shows a ninth alternative power tool according to the invention in a schematic perspective illustration.

### DESCRIPTION OF THE EXEMPLARY EMBODIMENTS

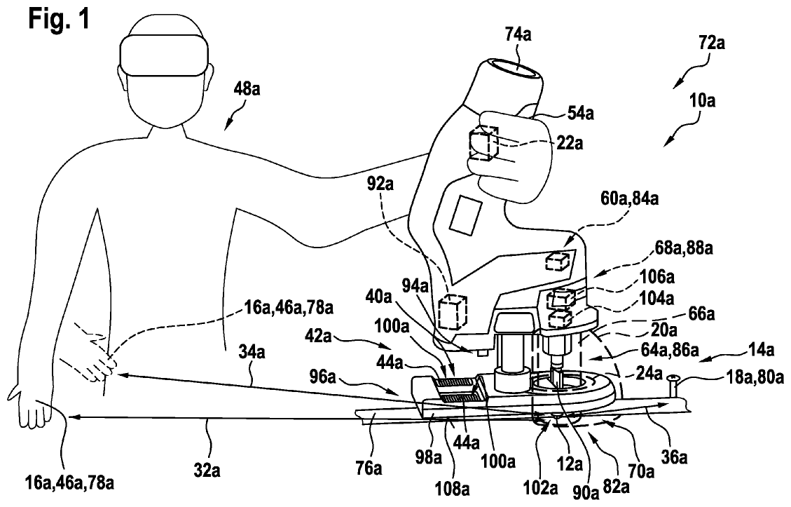

FIG. 1 shows a power tool 72a in a schematic perspective illustration. The power tool 72a comprises preferably at least one power tool device 10a. Preferably, the power tool device 10a comprises at least one motor-drivable machining tool 12a, at least one, in particular capacitive, sensor unit 14a, which is configured to sense at least one foreign body 16a, 18a in at least one detection area 20a around the machining tool 12a, and at least one open-loop and/or closed-loop control unit 22a, which is configured to trigger at least one action on the basis of at least one signal from the sensor unit 14a. Preferably, the power tool device 10a is in the form of a hand-held power tool device. In particular, the power tool 72a that comprises the power tool device 10a is in the form of a hand-held power tool. In particular, the power tool 72a is in the form of an electric power tool. In particular, the machining tool 12a is able to be driven by at least one electric motor of the power tool device 10a. Preferably, the power tool device 10a comprises at least one electrical energy storage unit 74a, in particular a rechargeable battery, for supplying energy at least to the electric motor. Alternatively, it is conceivable for the power tool device 10a to be in the form of a pneumatically powered power tool device, of a gasoline-powered power tool device or the like. Preferably, the power tool device 10a is intended for milling a workpiece 76a. In particular, the power tool 72a is in the form of a milling machine, in particular a trimmer. Alternatively, it is conceivable for the power tool 72a to be in the form of a plunge cut saw, of a tacker, of a tenon saw, of a foam saw, of a drywall cutter, of a plate jointer, of a belt grinder or sander, of a rotary tool, of a multi-cutter, of an, in particular autonomous, lawnmower, of a drilling machine, of an impact hammer, of a drywall screwdriver, of a heat gun, of a brushcutter, of a chopper, or of some other power tool that appears to make sense to a person skilled in the art. In particular, the machining tool 12a is in the form of a milling tool.

Preferably, the sensor unit 14a comprises at least one antenna 24a, which is configured to emit at least one electric and/or magnetic field that defines the at least one detection area 20a, and/or to sense the at least one foreign body 16a, 18a on the basis of at least one change in at least one electric and/or magnetic field. The sensor unit 14a is preferably in the form of an electric, in particular capacitive, sensor unit. In particular, the sensor unit 14a is configured differently than an optical, acoustic, haptic or similar sensor unit. In particular, the sensor unit 14a is configured for proximity detection. Preferably, the sensor unit 14a is configured to sense the at least one foreign body 16a, 18a prior to contact with the machining tool 12a. In FIG. 1, by way of example, two foreign bodies 16a, 18a are illustrated, which are able to be sensed by the sensor unit 14a. In particular, the sensor unit 14a is configured to sense the foreign bodies 16a, 18a at at least a particular distance 32a, 34a, 36a from the machining tool 12a, in particular within the detection area 20a around the machining tool 12a. The detection area 20a is in particular an area which extends around the machining tool 12a and in which the sensor unit 14a is able and set up to detect the foreign bodies 16a, 18a. Preferably, the detection area 20a extends asymmetrically around the machining tool 12a. Preferably, the detection area 20a has a greater extent around points of the machining tool 12a that represent a risk to a user 48a of the power tool device 10a, in particular along a cutting edge of the machining tool 12a, than at other points of the machining tool 12a. Alternatively, it is conceivable for the detection area 20a to extend symmetrically, in particular spherically, around the machining tool 12a.

The foreign bodies 16a, 18a may in particular be in the form of living objects, in particular of body parts 46a of the user 48a, for example a hand 78a, a finger, a leg or the like, of an animal or of some other living object that appears to make sense to a person skilled in the art. The foreign bodies 16a, 18a can in particular be in the form of inanimate objects, in particular of disruptive objects arranged on the workpiece 76a and/or extending in the vicinity of the workpiece 76a, for example of a nail 80a, of a power line, of a water pipe or the like. In the present exemplary embodiment, a foreign body 16a is in the form for example of a living object, in particular of a hand 78a of the user 48a, and a further foreign body 18a is in the form for example of an inanimate object, in particular of a nail 80 arranged on the workpiece 76a.

Preferably, the open-loop and/or closed-loop control unit 22a is connected to the sensor unit 14a for signal transmission purposes, in particular via at least one signal line (not illustrated here). Alternatively or additionally, it is conceivable for the open-loop and/or closed-loop control unit 22a to be connected to the sensor unit 14a for signal transmission purposes via a wireless signal connection. Preferably, the open-loop and/or closed-loop control unit 22a is configured to control the sensor unit 14a. The sensor unit 14a is in particular configured to provide the at least one signal, preferably a plurality of signals, to the open-loop and/or closed-loop control unit 22a, in particular on the basis of at least one of the foreign bodies 16a, 18a being sensed in the detection area 20a. Preferably, the open-loop and/or closed-loop control unit 22a is configured to evaluate the at least one signal received from the sensor unit 14a. In particular, the open-loop and/or closed-loop control unit 22a is configured to trigger the at least one action on the basis of an evaluation of the at least one signal from the sensor unit 14a.

The at least one action is preferably in the form of a safety function, in particular for preventing or at least for minimizing injury to the user 48a, and/or of a comfort function, in particular for making it easier for the user 48a to operate the power tool device 10a. The at least one action can in particular be in the form of braking of the machining tool 12a, of moving the machining tool 12a out of a risk area 82a, of shielding the machining tool 12a, of outputting at least one, in particular visual, audible and/or haptic, warning, of making an emergency call, or of some other action that appears to make sense to a person skilled in the art. In particular, the open-loop and/or closed-loop control unit 22a can be configured to trigger a plurality of, in particular different, actions. Preferably, the open-loop and/or closed-loop control unit 22a can be configured to trigger different actions on the basis of different signals from the sensor unit 14a. In particular, the open-loop and/or closed-loop control unit 22a is configured, on the basis of the at least one signal from the sensor unit 14a, in particular for triggering the at least one action, to control at least one reaction unit 84a, 86a, 88a of the power tool device 10a which is intended to carry out the at least one action. The at least one reaction unit 84a, 86a, 88a can in particular be in the form of a brake unit 60a, of a protective unit 64a, in particular of a covering unit, of a pivoting unit, of a blocking unit, of a signal output unit, of a communications unit, of a retraction unit 68a or of some other unit that appears to make sense to a person skilled in the art. In the present exemplary embodiment, the power tool device 10a comprises for example three reaction units 84a, 86a, 88a, wherein a first reaction unit 84a is in the form of a mechanical brake unit 60a, a second reaction unit 86a is in the form of a protective unit 64a and a third reaction unit 88a is in the form of a retraction unit 68a. The mechanical brake unit 60a is intended in particular to block an output shaft 90a of the power tool device 10a on which the machining tool 12a is mounted, in particular to block rotation of the output shaft 90a.

The at least one antenna 24a is preferably configured to conduct electric power. In particular, the at least one antenna 24a is formed in a cylindrical, in particular circular cylindrical, manner. In particular, the at least one antenna 24a is configured to emit an electric field that is distributed radially symmetrically about a longitudinal axis of the antenna 24a, and/or to emit a magnetic field that is distributed concentrically about the longitudinal axis of the antenna 24a. Preferably, the at least one antenna 24a is in the form of a cable, in particular of a coaxial cable, of a wire or the like. It is also conceivable for the antenna 24a to be formed from a plurality of electrodes. Alternatively or additionally, it is conceivable for the machining tool 12a and/or the output shaft 90a on which the machining tool 12a is mounted to form the at least one antenna 24a, and/or for the at least one antenna 24a to be configured to be electrically coupled to the machining tool 12a and/or to the output shaft 90a. Preferably, the machining tool 12a is in the form of the at least one antenna, wherein the sensor unit 14a has at least one further antenna 24a, which is formed separately from the machining tool 12a. In the present exemplary embodiment, the sensor unit 14a has for example the antenna 24a, which is formed separately from the machining tool 12a, in particular in the form of a coaxial cable. Alternatively or additionally, it is conceivable for the at least one antenna 24a to be formed separately from the power tool device 10a, in particular to be arranged on the user 48a, for example on a glove or on protective goggles of the user 48a.

In particular, the at least one antenna 24a is configured to emit at least one electromagnetic field. In particular, the electric and/or magnetic, in particular electromagnetic, field of the at least one antenna 24a, in particular a field strength and/or a maximum extent of the electric and/or magnetic field of the at least one antenna 24a, is dependent on an electric voltage applied to the at least one antenna 24a and/or on an electric current flowing through the at least one antenna 24a. In particular, the detection area 20a has at least substantially an identical shape to the electric and/or magnetic, in particular electromagnetic, field of the at least one antenna 24a. In particular, a boundary of the detection area 20a is defined by a sum of all the distances around the at least one antenna 24a which have an identical minimum, in particular predefined, field strength of the electric and/or magnetic field of the at least one antenna 24a. Preferably, the at least one antenna 24a is arranged in the vicinity 42a of the machining tool 12a. In particular, the sensor unit 14a can have a plurality of antennas 24a, in particular to realize full coverage of the machining tool 12a with a detection area 20a. In particular, the sensor unit 14a can have at least two antennas 24a, preferably at least four antennas 24a, particularly preferably at least six antennas 24a, and very particularly preferably at least 8 antennas 24a. In the present exemplary embodiment, the sensor unit 14a has for example the single antenna 24a.

Preferably, the at least one antenna 24a is configured to sense the foreign bodies 16a, 18a on the basis of a change in the electric and/or magnetic field emitted by the at least one antenna 24a. Alternatively or additionally, it is conceivable for the at least one antenna 24a to be configured to sense the foreign bodies 16a, 18a on the basis of a change in a further electric and/or magnetic field, in particular one emitted by another antenna. In particular, the sensor unit 14a can comprise at least two antennas 24a, wherein a first antenna 24a is configured to emit an electric and/or magnetic field and wherein a second antenna is configured to sense the foreign bodies 16a, 18a on the basis of a change in the electric and/or magnetic field of the first antenna 24a. In particular, the foreign bodies 16a, 18a arranged in the detection area 20a change the electric and/or magnetic field, in particular characteristics of the electric and/or magnetic field, in particular on the basis of electrical and/or magnetic properties of the foreign bodies 16a, 18a. Preferably, the at least one antenna 24a is configured to sense the foreign bodies 16a, 18a capacitively, in particular on the basis of a change in capacitance, brought about by the foreign bodies 16a, 18a, of the electric and/or magnetic field. Alternatively or additionally, it is conceivable for the at least one antenna 24a to be configured to sense the foreign bodies 16a, 18a inductively, in particular on the basis of a change in inductance, brought about by the foreign bodies 16a, 18a, of the electric and/or magnetic field.

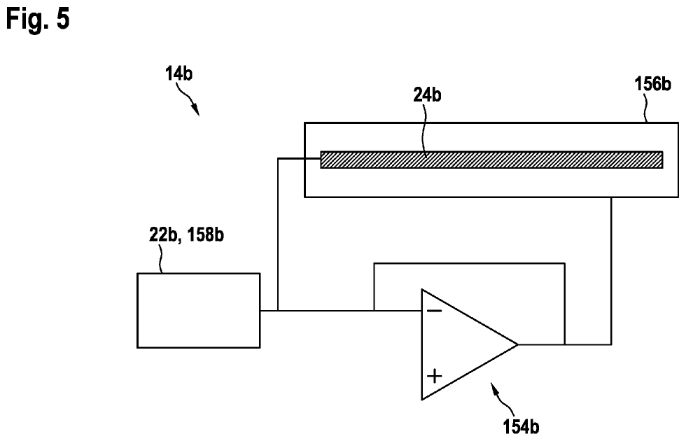

Preferably, the sensor unit 14a comprises at least one tuning circuit that is connected to the antenna 24a (not illustrated here; cf. 158b in FIG. 5). The tuning circuit is intended in particular at least to generate an electric and/or magnetic field through interaction with the antenna 24a. The tuning circuit is preferably formed at least from a resonant circuit, in particular an RLC resonant circuit, and from a phase stabilization circuit. Preferably, an operating frequency of the tuning circuit is less than 5 MHz. Alternatively, it is also conceivable, however, for the operating frequency of the tuning circuit to be greater than 5 MHz. The tuning circuit has in particular at least one amplifier, which is formed for example by a field effect transistor, a bipolar transistor, an operational amplifier or the like. Furthermore, various amplifier topologies are conceivable, for example a telescopic topology, a two-stage amplifier topology, a cascode topology or the like. The tuning circuit is preferably connected to a signal processing unit, in particular an analog-digital converter, wherein the signal processing unit is connectable, for signal transmission, at least to the open-loop and/or closed-loop control unit 22a. The signal processing unit comprises preferably at least one comparator, in particular a Schmitt trigger, which is usable for converting an analog signal, preferably from the antenna 24a, into a digital signal.

Preferably, the open-loop and/or closed-loop control unit 22a is configured to determine at least one movement characteristic of the at least one foreign body 16a, 18a and/or at least one distance 32a, 34a, 36a of the at least one foreign body 16a, 18a from the machining tool 12a on the basis of the at least one signal from the sensor unit 14a. Preferably, the open-loop and/or closed-loop control unit 22a is configured to trigger the at least one action on the basis of the at least one determined movement characteristic of the foreign bodies 16a, 18a and/or on the basis of the at least one determined distance 32a, 34a, 36a of the foreign bodies 16a, 18a from the machining tool 12a. In particular, the open-loop and/or closed-loop control unit 22a is configured to evaluate the at least one determined movement characteristic of the foreign bodies 16a, 18a and/or the at least one determined distance 32a, 34a, 36a of the foreign bodies 16a, 18a from the machining tool 12a and to trigger the at least one action in particular on the basis of a result of the evaluation. The at least one movement characteristic of the foreign bodies 16a, 18a is preferably in the form of a speed of movement of the foreign bodies 16a, 18a, in particular of a speed at which the foreign bodies 16a, 18a approach the machining tool 12a, of an acceleration of movement of the foreign bodies 16a, 18a, in particular of an acceleration with which the foreign bodies 16a, 18a approach the machining tool 12a, of a direction of movement of the foreign bodies 16a, 18a or of some other movement characteristic that appears to make sense to a person skilled in the art. In particular, the open-loop and/or closed-loop control unit 22a is configured to determine the distance 32a, 34a, 36a of the foreign bodies 16a, 18a from the machining tool 12a, in particular a position of the foreign bodies 16a, 18a at least relative to the machining tool 12a, on the basis of the at least one signal from the sensor unit 14a. Preferably, the open-loop and/or closed-loop control unit 22a is configured to determine the at least one movement characteristic of the foreign bodies 16a, 18a on the basis of a plurality of signals from the sensor unit 14a, in particular signals that are sensed with a time offset. In particular, the open-loop and/or closed-loop control unit 22a is configured to determine the speed of movement of the foreign bodies 16a, 18a, in particular the speed at which the foreign bodies 16a, 18a approach the machining tool 12a, on the basis of a period of time that has passed between two operations of sensing and/or determining the foreign bodies 16a, 18a at two different distances 32a, 34a, 36a from the machining tool 12a, in particular at two different positions, and on the basis of a spatial difference between the two different distances 32a, 34a, 36a from the machining tool 12a, in particular between the two different positions. Preferably, the open-loop and/or closed-loop control unit 22a is configured to determine the acceleration of the movement of the foreign bodies 16a, 18a, in particular the acceleration with which the foreign bodies 16a, 18a approach the machining tool 12a, on the basis of different determined speeds of movement of the foreign bodies 16a, 18a at different distances 32a, 34a, 36a from the machining tool 12a, in particular at different positions. In the present exemplary embodiment, the foreign body 16a in the form of a hand 78a of the user 48a is for example at a distance 32a from the machining tool 12a. FIG. 1 additionally illustrates a further distance 34a of the foreign body 16a from the machining tool 12a, which is in particular smaller than the distance 32a of the foreign body 16a from the machining tool 12a, in particular on account of an interim movement of the foreign body 16a in the direction of the machining tool 12a. In the present exemplary embodiment, the further foreign body 18a in the form of a nail 80a is for example at a distance 36a from the machining tool 12a.

Preferably, the open-loop and/or closed-loop control unit 22a is configured to determine the distance 32a, 34a, 36a of the foreign bodies 16a, 18a from the machining tool 12a, in particular the position of the foreign bodies 16a, 18a at least relative to the machining tool 12a, on the basis of a signal strength of the signal sensed by the sensor unit 14a, in particular on the basis of a level in the change of the electric and/or magnetic field of the at least one antenna 24a. Alternatively or additionally, it is conceivable for the sensor unit 14a to be configured to provide a plurality of detection areas 20a with different radii around the machining tool 12a, wherein the open-loop and/or closed-loop control unit 22a is configured in particular to determine the distance 32a, 34a, 36a of the foreign bodies 16a, 18a from the machining tool 12a, in particular the position of the foreign bodies 16a, 18a, on the basis of the foreign bodies 16a, 18a being sensed in a particular detection area 20a (this not being illustrated in further detail here). Preferably, the at least one antenna 24a is configured to provide the plurality of detection areas 20a with different radii around the machining tool 12a. Alternatively or additionally, it is conceivable for the sensor unit 14a to comprise a plurality of antennas 24a, in particular a number of antennas 24a corresponding to a number of detection areas 20a to be provided, wherein in particular in each case one antenna 24a is configured to provide at least one of the plurality of detection areas 20a. Preferably, the detection areas 20a may be in the form of layers or shells, in particular cylindrical shells, spherical shells or the like. In particular, the detection areas 20a may have equidistant extents between one another as seen along the radii of the detection areas 20a. Alternatively, it is conceivable for the detection areas 20a to have different extents between one another as seen along the radii of the detection areas 20a.

Preferably, the open-loop and/or closed-loop control unit 22a is configured to trigger different actions on the basis of different determined movement characteristics of the at least one foreign body 16a, 18a and/or on the basis of different determined distances 32a, 34a, 36a of the at least one foreign body 16a, 18a from the machining tool 12a. In particular, a plurality of different movement characteristics of the foreign bodies 16a, 18a and/or of different distances 32a, 34a, 36a of the foreign bodies 16a, 18a from the machining tool 12a and a plurality of actions to be triggered that are associated with the different movement characteristics and/or the different distances 32a, 34a, 36a of the foreign bodies 16a, 18a can be stored in a memory unit of the open-loop and/or closed-loop control unit 22a. Preferably, the open-loop and/or closed-loop control unit 22a is configured to compare the determined movement characteristic of the foreign bodies 16a, 18a and/or the determined distance 32a, 34a, 36a of the foreign bodies 16a, 18a with the movement characteristics and/or distances 32a, 34a, 36a of the foreign bodies 16a, 18a that are stored in the memory unit. In particular, the open-loop and/or closed-loop control unit 22a is configured to trigger the at least one action associated with the determined movement characteristic and/or the determined distance 32a, 34a, 36a of the foreign bodies 16a, 18a on the basis of the comparison.

For example, it is conceivable for the open-loop and/or closed-loop control unit 22a to be configured to trigger an output of a warning signal on the basis of a determined first speed of movement of the foreign bodies 16a, 18a and/or on the basis of a determined first distance 32a of the foreign bodies 16a, 18a from the machining tool 12a. For example, it is conceivable for the open-loop and/or closed-loop control unit 22a to be configured to trigger a reduction in rotational speed of a motor 92a driving the machining tool 12a on the basis of a determined second speed of movement of the foreign bodies 16a, 18a that is faster than the first speed of movement of the foreign bodies 16a, 18a and/or on the basis of a determined second distance 34a of the foreign bodies 16a, 18a from the machining tool 12a that is less than the determined first distance 32a of the foreign bodies 16a, 18a from the machining tool 12a. For example, it is conceivable for the open-loop and/or closed-loop control unit 22a to be configured to trigger braking of the motor 92a driving the machining tool 12a and/or of the machining tool 12a on the basis of a determined third speed of movement of the foreign bodies 16a, 18a that is faster than the second speed of movement of the foreign bodies 16a, 18a and/or on the basis of a determined third distance 36a of the foreign bodies 16a, 18a from the machining tool 12a that is less than the determined second distance 34a of the foreign bodies 16a, 18a from the machining tool 12a.

Preferably, the open-loop and/or closed-loop control unit 22a is configured to determine a probability of contact of the at least one foreign body 16a, 18a with the moving machining tool 12a on the basis of the at least one movement characteristic of the at least one foreign body 16a, 18a and/or of the at least one distance 32a, 34a, 36a of the at least one foreign body 16a, 18a from the machining tool 12a and on the basis of a minimum time for braking the machining tool 12a to a standstill. In particular, the open-loop and/or closed-loop control unit 22a is configured to evaluate the at least one movement characteristic of the foreign bodies 16a, 18a and/or the at least one distance 32a, 34a, 36a of the foreign bodies 16a, 18a from the machining tool 12a and the minimum time for braking the machining tool 12a to a standstill in order to determine the probability of contact of the foreign bodies 16a, 18a with the moving machining tool 12a.

In particular, the open-loop and/or closed-loop control unit 22a is configured to determine the minimum time for braking the machining tool 12a to a standstill, in particular on the basis of characteristics of the machining tool 12a, for example an inertia of the machining tool 12a, a rotational speed of the machining tool 12a, a speed of movement of the machining tool 12a or the like, and on the basis of available braking possibilities for braking the machining tool 12a to a standstill, for example a maximum braking force of the brake unit 60a of the power tool device 10a, a minimum activation duration of the brake unit 60a, a minimum time until engagement of the brake unit 60a or the like. In particular, the power tool device 10a can have at least one sensing unit 94a which is configured to sense the characteristics of the machining tool 12a and the available braking possibilities and to provide them to the open-loop and/or closed-loop control unit 22a. Alternatively or additionally, it is conceivable for the maximum time for braking the machining tool 12a to a standstill and/or at least the characteristics of the machining tool 12a and/or the available braking possibilities to be stored in the memory unit of the open-loop and/or closed-loop control unit 22a. Preferably, the open-loop and/or closed-loop control unit 22a is configured to trigger the at least one action on the basis of the determined probability of contact of the foreign bodies 16a, 18a with the moving machining tool 12a, in particular on the basis of an evaluation of the determined probability of contact of the foreign bodies 16a, 18a with the moving machining tool 12a.

Preferably, the open-loop and/or closed-loop control unit 22a is configured to trigger a different action on the basis of the probability of contact being below a probability threshold value than on the basis of the probability of contact being above the probability threshold value. The probability threshold value is preferably stored in the memory unit of the open-loop and/or closed-loop control unit 22a. In particular, the probability threshold value is in the form of a value of a probability of contact of the foreign bodies 16a, 18a with the moving machining tool 12a of between 0% and 100%, for example 10%. Preferably, the open-loop and/or closed-loop control unit 22a is configured to compare the determined probability of contact with the probability threshold value and to trigger the at least one action on the basis of the comparison. For example, it is conceivable for the open-loop and/or closed-loop control unit 22a to be configured to trigger braking of the machining tool 12a on the basis of the probability of contact being below the probability threshold value and to additionally trigger the making of an emergency call on the basis of the probability of contact being above the probability threshold value.

Preferably, the open-loop and/or closed-loop control unit 22a is configured to classify different foreign bodies 16a, 18a sensed by the sensor unit 14a and to trigger different actions on the basis of different classifications. In particular, the open-loop and/or closed-loop control unit 22a is configured to distinguish between different types of foreign bodies 16a, 18a on the basis of different signals from the sensor unit 14a, in the present exemplary embodiment for example between the foreign body 16a and the further foreign body 18a. In particular, different types of foreign bodies 16a, 18a have different electrical and/or magnetic, in particular capacitive, properties, and in particular influence the electric and/or magnetic field of the antenna 24a differently. In particular, each type of foreign body 16a, 18a has its own electrical and/or magnetic, in particular capacitive, signature. Preferably, the open-loop and/or closed-loop control unit 22a is configured to identify a type of the foreign body 16a, 18a on the basis of the electrical, in particular capacitive, signature of the foreign body 16a, 18a and to classify the foreign body 16a, 18a. Preferably, electrical and/or magnetic, in particular capacitive, signatures of different types of foreign bodies 16a, 18a are stored in the memory unit of the open-loop and/or closed-loop control unit 22a. In particular, the open-loop and/or closed-loop control unit 22a is configured to compare a signal from the sensor unit 14a corresponding to sensing of a foreign body 16a, 18a with the stored signatures and to classify the foreign body 16a, 18a on the basis of the comparison.

In particular, the open-loop and/or closed-loop control unit 22a is configured to distinguish between living and inanimate foreign bodies 16a, 18a on the basis of different signals from the sensor unit 14a and to accordingly classify the foreign bodies 16a, 18a. Preferably, the open-loop and/or closed-loop control unit 22a is configured to distinguish between human and animal living foreign bodies 16a on the basis of different signals from the sensor unit 14a and to accordingly classify the foreign bodies 16a. In the present exemplary embodiment, the open-loop and/or closed-loop control unit 22a is configured for example to classify the hand 78a of the user 48a as the human living foreign body 16a. Preferably, the open-loop and/or closed-loop control unit 22a is configured to distinguish between inanimate foreign bodies 18a of different material on the basis of different signals from the sensor unit 14a and to accordingly classify the foreign bodies 18a. In the present exemplary embodiment, the open-loop and/or closed-loop control unit 22a is configured for example to classify the nail 80a as the inanimate foreign body 18a made of a metal. Preferably, different actions to be triggered that are associated with the different classifications of foreign bodies 16a, 18a are stored in the memory unit of the open-loop and/or closed-loop control unit 22a. In particular, the open-loop and/or closed-loop control unit 22a is configured to trigger at least one action associated with a classification of a sensed foreign body 16a, 18a. For example, it is conceivable for the open-loop and/or closed-loop control unit 22a to be configured to trigger pivoting of the machining tool 12a away from the risk area 82a on the basis of the sensed further foreign body 18a being classified as an inanimate foreign body 18a and to trigger mechanical braking of the machining tool 12a on the basis of the sensed foreign body 16a being classified as a living foreign body 16a.

Preferably, the power tool device 10a comprises at least one further sensor unit 40a which has at least one contact sensor element 44a, arranged in the vicinity 42a, in particular in the abovementioned vicinity 42a, in the form of a guide region, of the machining tool 12a, for sensing at least one body part 46a of a user 48a, in particular of the abovementioned user 48a. Preferably, a power tool 72a in the form of a milling machine, in particular of a router, of a saw, in particular of a chain saw, or of a hedge trimmer, for example in the form of a trimmer in the present exemplary embodiment, comprises the power tool device 10a that has the at least one guide region. Preferably, the guide region is formed at least partially by a base unit 96a of the power tool device 10a, in particular by a guide element 98a of the base unit 96a, for example a sliding shoe, as in the present exemplary embodiment for example, or a handle. Preferably, the machining tool 12a, in particular the output shaft 90a, extends at least partially through the guide element 98a, formed in particular as a sliding shoe. In particular, the power tool device 10a is guidable along the workpiece 76a by means of the guide element 98a. In particular, the guide element 98a, formed in particular as a sliding shoe, is intended to bear on the workpiece 76a. Preferably, the guide element 98a is intended to be grasped, in particular in the guide region, by the user 48a, in particular to effect controlled guidance of the power tool device 10a. Preferably, the at least one contact sensor element 44a is arranged on the guide element 98a, in particular integrated in the guide element 98a with a precise fit. In the present exemplary embodiment, the further sensor unit 40a has for example two contact sensor elements 44a, which are arranged in particular on sides of the guide element 98a that face away from one another. In particular, the contact sensor elements 44a are arranged in recessed grips 100a of the guide element 98a.

Preferably, the contact sensor elements 44a are in the form of capacitive sensors, as for example in the present exemplary embodiment, of pressure-sensitive sensors, of fingerprint scanners, of conductivity sensors, or of other contact sensor elements that appear to make sense to a person skilled in the art. Preferably, the further sensor unit 40a is connected to the open-loop and/or closed-loop control unit 22a for signal transmission purposes, in particular via a signal line and/or a wireless connection (not illustrated here). In particular, the further sensor unit 40a is configured to provide at least one signal to the open-loop and/or closed-loop control unit 22a on the basis of sensing of the at least one body part 46a, in particular at least one finger, of the user 48a. Preferably, the open-loop and/or closed-loop control unit 22a is configured to trigger the at least one action on the basis of the at least one signal from the further sensor unit 40a, in particular on the basis of sensing of the at least one body part 46a in the guide region. For example, it is conceivable for the open-loop and/or closed-loop control unit 22a to be designed to activate the motor 92a that drives the machining tool 12a on the basis of sensing of the body part 46a. For example, it is conceivable for the open-loop and/or closed-loop control unit 22a to be configured to deactivate the motor 92a that drives the machining tool 12a on the basis of a lack of sensing of the body part 46a, in particular to prevent uncontrolled guidance of the power tool device 10a.

Preferably, the open-loop and/or closed-loop control unit 22a is configured to adapt at least one parameter, in particular the at least one detection area 20a, at least partially autonomously on the basis of at least one signal from the further sensor unit 40a. Preferably, the open-loop and/or closed-loop control unit 22a is configured to adapt the at least one parameter entirely autonomously, in particular automatically, on the basis of the at least one signal from the further sensor unit 40a. Alternatively, it is conceivable for the open-loop and/or closed-loop control unit 22a to be configured to adapt the at least one parameter partially autonomously. In particular, the open-loop and/or closed-loop control unit 22a can be configured to provide the user 48a, on the basis of the at least one signal from the further sensor unit 40a, in particular on the basis of the evaluation of the at least one signal from the further sensor unit 40a, with at least one recommendation for adaptation of the at least one parameter, for example via a signal output unit of the power tool device 10a, and to adapt the at least one parameter on the basis of a user input. In particular, the open-loop and/or closed-loop control unit 22a can be configured to adapt a plurality of parameters at least partially autonomously on the basis of the at least one signal from the further sensor unit 40a. The at least one parameter to be adapted can in particular be in the form of a sensitivity of the sensor unit 14a, of the detection area 20a, in particular of the extent of the detection area 20a, of the shape of the detection area 20a or the like, of a type of the at least one action to be triggered, of a sequence of a number of actions to be triggered, of a triggering speed and/or of a speed at which the at least one action is carried out, for example a braking speed of the machining tool 12a, or of some other parameter that appears to make sense to a person skilled in the art.

Preferably, the open-loop and/or closed-loop control unit 22a is configured to adapt the detection area 20a, in particular the extent of the detection area 20a, in particular to make it larger or smaller, at least partially autonomously on the basis of the at least one signal from the further sensor unit 40a. In particular, the open-loop and/or closed-loop control unit 22a is configured, on the basis of a signal from the further sensor unit 40a corresponding to sensing of the at least one body part 46a in the guide region, to at least partially autonomously set the detection area 20a, in particular a maximum extent of the detection area 20a, to be smaller than a minimum distance between the machining tool 12a and the guide region, in particular to avoid erroneous triggering by the body part 46a. In particular, the open-loop and/or closed-loop control unit 22a is configured, on the basis of a signal from the further sensor unit 40a corresponding to a lack of sensing of the at least one body part 46a in the guide region, to at least partially autonomously set the detection area 20a, in particular a maximum extent of the detection area 20a, to be larger than a minimum distance between the machining tool 12a and the guide region, in particular to reduce a risk of injury as a result of incorrect operation of the power tool device 10a.

Preferably, the power tool device 10a comprises at least one protective unit 64a, in particular the abovementioned protective unit 64a, which has at least one shielding element 66a, wherein the open-loop and/or closed-loop control unit 22a is configured to control the protective unit 64a to move the at least one shielding element 66a around the machining tool 12a on the basis of the at least one signal from the sensor unit 14a. In particular, the power tool device 10a has the protective unit 64a as an alternative or, as for example in the present exemplary embodiment, in addition to the mechanical brake unit 60a. Preferably, the shielding element 66a is intended to at least partially cover, in particular to enclose, the machining tool 12a. In FIG. 1, the protective unit 64a is illustrated for example in an activated state, in which the shielding element 66a at least partially covers the machining tool 12a. In particular, the shielding element 66a is intended to cover, in particular to enclose, at least one risk area 102a, in particular at least one milling edge, of the machining tool 12a. Preferably, the shielding element 66a is intended to protect the foreign body 16a, in particular the body part 46a of the user 48a, from the machining tool 12a and/or the machining tool 12a from the further foreign body 18a. In particular, the shielding element 66a is intended to prevent the machining tool 12a from being grasped, in particular by the user 48a. The shielding element 66a can in particular be in the form of a shielding hood, as for example in the present exemplary embodiment, of a shielding cover, of an airbag, of a cage or of some other shielding element that appears to make sense to a person skilled in the art. In particular, the shielding element 66a is mounted movably on, in particular at least partially within, the base unit 96a of the power tool device 10a, in particular of a housing 54a of the base unit 96a. In particular, the shielding element 66a can be formed in a telescopic, as for example in the present exemplary embodiment, inflatable, clampable or similar manner. Preferably, the protective unit 64a comprises at least one actuator 104a, which is intended to move the shielding element 66a around the machining tool 12a and/or to enable the shielding element 66a to be moved by at least one further actuator of the protective unit 64a. In particular, the open-loop and/or closed-loop control unit 22a is configured to control the actuator 104a to move the shielding element 66a around the machining tool 12a on the basis of the at least one signal from the sensor unit 14a. The at least one actuator 104a can in particular be in the form of an electromagnetic actuator, of a spring force actuator, of a compressed-air actuator, of an explosive actuator, of a fuse wire actuator, of a shape memory actuator or of some other actuator that appears to make sense to a person skilled in the art.

Preferably, the power tool device 10a comprises at least one retraction unit 68a, wherein the open-loop and/or closed-loop control unit 22a is configured to control the retraction unit 68a to move the machining tool 12a out of a machining area 70a on the basis of the at least one signal from the sensor unit 14a. In particular, the power tool device 10a has the retraction unit 68a as an alternative or, as for example in the present exemplary embodiment, in addition to the mechanical brake unit 60a and/or to the protective unit 64a. The machining area 70a is in particular an area within the detection area 20a. In particular, the machining area 70a can correspond to the detection area 20a. In particular, at least the machining tool 12a and at least the workpiece 76a are arranged at least partially in the machining area 70a. In particular, in the machining area 70a, there is a risk of injury for the user 48a by touching the machining tool 12a and/or a risk of damage for the machining tool 12a by touching the foreign body 18a. In FIG. 1, the retraction unit 68a is illustrated for example in a deactivated state, in which the machining tool 12a is arranged in particular in the machining area 70a. The retraction unit 68a is preferably intended to pull, in particular to retract, as for example in the present exemplary embodiment, to push, to drive or pivot the machining tool 12a out of the machining area 70a or to move it out of the machining area 70a in some other way that appears to make sense to a person skilled in the art. Preferably, the retraction unit 68a is intended to move the machining tool 12a away from the sensed foreign bodies 16a, 18a. In particular, the retraction unit 68a is intended to move the machining tool 12a at least partially into an at least partially covered area of the power tool device 10a, for example into the base unit 96a, in particular into the housing 54a, into a protective hood or the like.

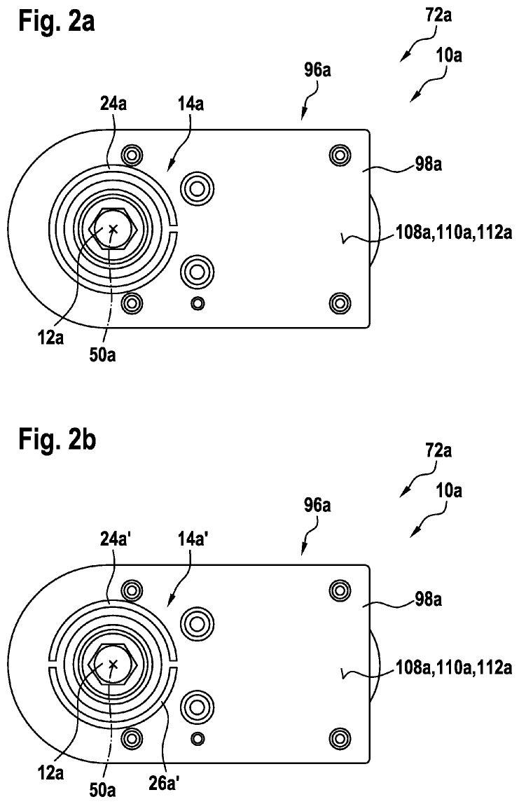

Preferably, the retraction unit 68a comprises at least one actuator 106a, which is intended to move the machining tool 12a out of the machining area 70a. The actuator 106a is preferably operatively connected to the machining tool 12a, in particular directly, for example mechanically, magnetically or the like, and/or indirectly, for example via a pivot arm, the output shaft 90a, as for example in the present exemplary embodiment, or the like. Preferably, the machining tool 12a and/or at least one component on which the machining tool 12a is mounted, for example the output shaft 90a, as for example in the present exemplary embodiment, the pivot arm or the like, is/are mounted movably, in particular so as to be movable out of the machining area 70a. In particular, the open-loop and/or closed-loop control unit 22a is configured to control the actuator 106a to move the machining tool 12a out of the machining area 70a on the basis of the at least one signal from the sensor unit 14a. The at least one actuator 106a can in particular be in the form of an electromagnetic actuator, of a spring force actuator, of a compressed-air actuator, of an explosive actuator, of a fuse wire actuator, of a shape memory actuator or of some other actuator that appears to make sense to a person skilled in the art. In particular, the actuator 106a and/or the open-loop and/or closed-loop control unit 22a can be intended to use brake energy of braking of the machining tool 12a and/or at least one electric current from motor braking of the motor 92a driving the machining tool 12a to move the machining tool 12a. The actuator 106a can in particular be intended to uncouple the machining tool 12a and/or the output shaft 90a from the motor 92a driving the machining tool 12a in order to move the machining tool 12a out of the machining area 70a. In particular, the retraction unit 68a can have ramp elements along which the machining tool 12a and/or the output shaft 90a can slide out of the machining area 70a on the basis of motion energy, in particular rotational energy, of the machining tool 12a and/or of the output shaft 90a (this not being illustrated here). FIG. 2a shows the power tool 72a from FIG. 1, in particular an underside 108a of the guide element 98a, in a schematic illustration. The underside 108a of the guide element 98a is in particular in the form of a sliding face 110a of the power tool device 10a. Preferably, the at least one antenna 24a is arranged in the form of a ring about a longitudinal axis 50a of the machining tool 12a. Preferably, a power tool 72a in the form of a router, of a trimmer, of a jigsaw or of a reciprocating saw, in the present exemplary embodiment for example the power tool 72a in the form of a trimmer, comprises the power tool device 10a having the at least one antenna 24a that is arranged in the form of a ring about the longitudinal axis 50a of the machining tool 12a. Preferably, the at least one antenna 24a is arranged in a plane 112a, in particular in the sliding face 110a, which extends transversely, in particular perpendicularly, to the longitudinal axis 50a of the machining tool 12a. Preferably, the at least one antenna 24a is arranged in the form of a circular ring, of a partial ring, in particular of a half ring, or the like, about the longitudinal axis 50a of the machining tool 12a. In the present exemplary embodiment, the antenna 24a is arranged for example in the form of a circular ring, in particular locally interrupted. Preferably, the at least one antenna 24a is arranged on the base unit 96a of the power tool device 10a, in particular on the guide element 98a, in the form in particular of a sliding shoe. In particular, the at least one antenna 24a can be arranged at least partially within the base unit 96a, in particular within the guide element 98a. Preferably, the sensor unit 14a can have a plurality of antennas 24a, wherein in particular two antennas 24a can be arranged on sides of the guide element 98a that face away from one another. Preferably, the at least one antenna 24a is arranged in the at least one plane 112a that extends parallel to the sliding face 110a of the guide element 98a, in the form in particular of a sliding shoe. FIG. 2b shows the power tool 72a from FIG. 1, in particular an underside 108a of a guide element 98a, with an alternative sensor unit 14a′ in a schematic illustration. In particular, the sensor unit 14a′ comprises two antennas 24a′, 26a′, in particular a first antenna 24a′ and a second antenna 26a′. Preferably, the antennas 24a′, 26a′ are arranged in the form of a half ring about a longitudinal axis 50a of a machining tool 12a. In particular, the antennas 24a′, 26a′ are arranged so as not to be connected to one another. In particular, the antennas 24a′, 26a′ each form a circular ring segment, in particular of a locally interrupted circular ring.

FIG. 2c shows the power tool 72a from FIG. 1, in particular an underside 108a of a guide element 98a, with a further alternative sensor unit 14a″ in a schematic illustration. In particular, the sensor unit 14a″ comprises four antennas 24a″, 26a″, 28a″, 30a″, in particular a first antenna 24a″, a second antenna 26a″, a third antenna 28a″ and a fourth antenna 30a″. Preferably, the antennas 24a″, 26a″, 28a″, 30a″ are arranged in the form of a quarter circular ring about a longitudinal axis 50a of a machining tool 12a. In particular, the antennas 24a″, 26a″, 28a″, 30a″ are arranged so as not to be connected to one another. In particular, the antennas 24a″, 26a″, 28a″, 30a″ each form a circular ring segment, in particular of a locally interrupted circular ring.

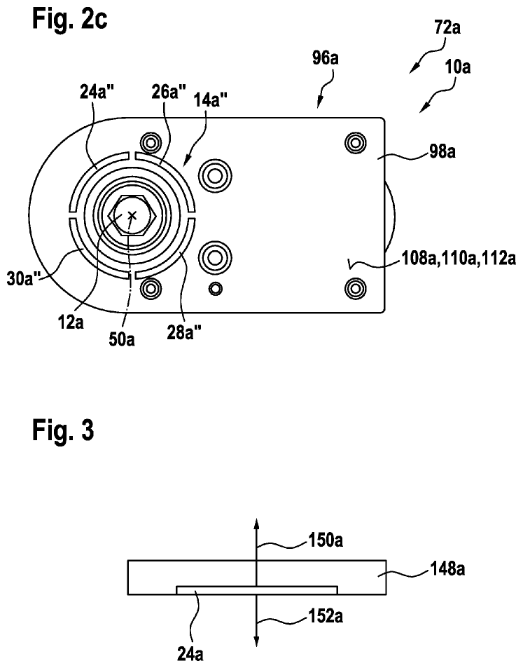

FIG. 3 shows a sectional view of a part of the power tool 72a from FIG. 2a in a schematic illustration, in which at least the antenna 24a of the sensor unit 14a is depicted. Preferably, the sensor unit 14a comprises at least one field shielding element 148a which is formed in particular integrally with the antenna 24a and is configured to shield an electric and/or magnetic field, emitted by the antenna 24a, in at least one emission direction 150a. The field shielding element 148a is formed preferably from a material that is not transparent to electromagnetic radiation, preferably to electric and/or magnetic fields, in particular from a metal, for example from a lead, from an iron, from a steel or the like. It is also conceivable for the antenna 24a to be formed partially by a coaxial cable, wherein the coaxial cable forms the field shielding element 148a. In particular, the field shielding element 148a is intended to absorb and/or reflect the electric and/or magnetic field of the antenna 24a in the emission direction 150a. In addition, it is conceivable for the field shielding element 148a to be configured to focus the electric and/or magnetic field of the antenna 24a in at least one emission direction 152a without shielding. In particular, the antenna 24a is arranged without shielding as seen in at least one emission direction 152a. In particular, at least one risk area of the machining tool is arranged in the at least one emission direction 152a, as seen in which the at least one antenna 24a is arranged without shielding (this not being illustrated here).

In the following text, a method for operating a power tool device, in particular the abovementioned power tool device 10a, is described, in particular with reference to FIG. 1. Preferably, in at least one method step, by means of at least one antenna 24a, in particular the at least one abovementioned antenna 24a, at least one electric and/or magnetic field is emitted, said field defining at least one detection area 20a about at least one machining tool 12a, in particular about the abovementioned machining tool 12a, of the power tool device 10a, and/or, by means of the at least one antenna 24a, at least one foreign body 16a, 18a is sensed on the basis of at least one change in at least one electric and/or magnetic field.

Preferably, in at least one further method step, at least one movement characteristic of the at least one foreign body 16a, 18a and/or at least one distance 32a, 34a, 36a of the at least one foreign body 16a, 18a from the machining tool 12a is/are determined on the basis of at least one signal from at least one sensor unit 14a, in particular the abovementioned sensor unit 14a, of the power tool device 10a. As far as other method steps of the method for operating the power tool device 10a are concerned, reference may be made to the above description of the power tool device 10a, since this description can also be read analogously onto the method and therefore all the features relating to the power tool device 10a are considered to also be disclosed in relation to the method for operating the power tool device 10a.

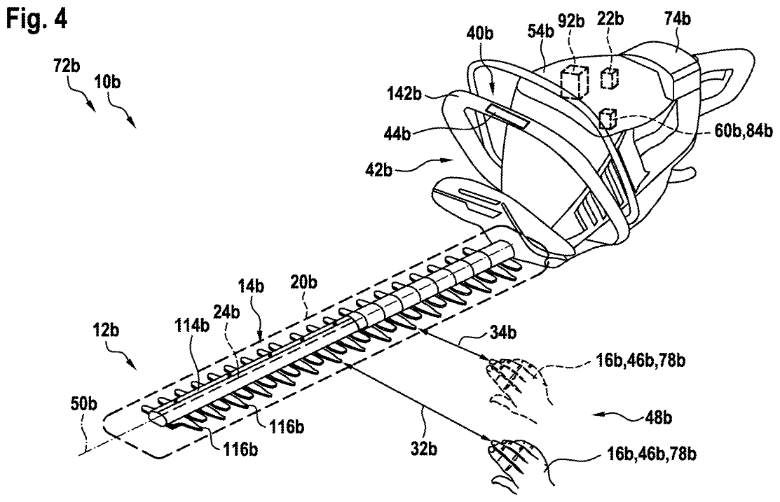

FIGS. 4 to 12 show nine further exemplary embodiments of the invention. The following descriptions and the drawings are restricted substantially to the differences between the exemplary embodiments, wherein, as far as identically referenced components are concerned, in particular as far as components with identical reference signs are concerned, reference may also be made in principle to the drawings and/or the description of the other exemplary embodiments, in particular FIGS. 1 to 3. To distinguish between the exemplary embodiments, the letter a is placed after the reference signs of the exemplary embodiment in FIGS. 1 to 3. In the exemplary embodiments in FIGS. 4 to 12, the letter a has been replaced by the letters b to j.

FIG. 4 shows a first alternative power tool 72b in a schematic perspective illustration. The power tool 72b is in particular in the form of a hedge trimmer. The power tool 72b comprises in particular a power tool device 10b. Preferably, the power tool device 10b is intended for machining a workpiece by cutting and/or sawing. Preferably, the power tool device 10b comprises at least one motor-drivable machining tool 12b, in particular at least one blade. In particular, the machining tool 12b is mounted on a guide bar element 114b of the power tool device 10b. Preferably, the power tool device 10b comprises at least one, in particular capacitive, sensor unit 14b, which is configured to sense at least one foreign body 16b in at least one detection area 20b around the machining tool 12b, and at least one open-loop and/or closed-loop control unit 22b, which is configured to trigger at least one action on the basis of at least one signal from the sensor unit 14b. Preferably, the sensor unit 14b comprises at least one antenna 24b, which is configured to emit at least one electric and/or magnetic field, which defines the at least one detection area 20b, and/or to sense the at least one foreign body 16b on the basis of at least one change in at least one electric and/or magnetic field. Preferably, the open-loop and/or closed-loop control unit 22b is configured to trigger at least braking of the machining tool 12b on the basis of the at least one signal from the sensor unit 14b corresponding to sensing of the foreign body 16b in the detection area 20b, in particular by controlling a mechanical brake unit 60b of the power tool device 10b.

Preferably, the open-loop and/or closed-loop control unit 22b is configured to determine a probability of contact of the at least one foreign body 16b with the moving machining tool 12b on the basis of at least one movement characteristic of the at least one foreign body 16b and/or of at least one distance 32b, 34b of the at least one foreign body 16b from the machining tool 12b and on the basis of a minimum time for braking the machining tool 12b to a standstill. In FIG. 4, the foreign body 16b, in particular a hand 78b of a user 48b, is illustrated for example at two different distances 32b, 34b from the machining tool 12b. Preferably, the open-loop and/or closed-loop control unit 22b is configured to trigger a different action on the basis of the probability of contact being below a probability threshold value than on the basis of the probability of contact being above the probability threshold value. For example, it is conceivable for the open-loop and/or closed-loop control unit 22b to be configured to trigger a movement of movable teeth 116b of the machining tool 12b, in particular of the hedge trimmer, into a closed position, in particular to prevent the user 48b being injured on the stationary but sharp-edged teeth 116b, on the basis of the probability of contact being below the probability threshold value. For example, it is conceivable for the open-loop and/or closed-loop control unit 22b to be configured to trigger a movement of the movable teeth 116b of the machining tool 12b into an opened position, in particular to prevent a body part 46b of the user 48b being severed by the teeth 116b moving into the closed position on contact with the machining tool 12b, on the basis of the probability of contact being above the probability threshold value. In particular, the open-loop and/or closed-loop control unit 22b is configured to control a motor 92b, driving the machining tool 12b, of the power tool device 10b to trigger a movement, in particular travel, of the teeth 116b of the machining tool 12b.

Preferably, the power tool device 10b comprises at least one further sensor unit 40b, which has at least one contact sensor element 44b, arranged in the vicinity 42b, in the form of a guide region, of the machining tool 12b, in particular on an auxiliary handle 142b of the power tool device 10b, for sensing the at least one body part 46b of the user 48b. Preferably, the open-loop and/or closed-loop control unit 22b is configured to adapt a parameter at least partially autonomously on the basis of at least one signal from the further sensor unit 40b. In particular, the open-loop and/or closed-loop control unit 22b is configured to activate the motor 92b on the basis of the at least one signal from the further sensor unit 40b corresponding to sensing of the body part 46b of the user 48b.

Preferably, the at least one antenna 24b is arranged parallel to a longitudinal axis 50b of the machining tool 12b. In particular, the at least one antenna 24b is arranged parallel to the longitudinal axis 50b of the machining tool 12b alternatively, as for example in the present exemplary embodiment, or additionally to being arranged in the form of a ring about the longitudinal axis 50b of the machining tool 12b. In particular, the sensor unit 14b can, in an alternative configuration, have at least two antenna 24b, wherein one antenna is arranged in the form of a ring about the longitudinal axis 50b of the machining tool 12b and a further antenna 24b is arranged parallel to the longitudinal axis 50b of the machining tool 12b. Preferably, a power tool 72b in the form of a hedge trimmer, as for example in the present exemplary embodiment, of a chain saw, of a router, of a trimmer, of a jigsaw or of a reciprocating saw comprises the power tool device 10b having the at least one antenna 24b that is arranged parallel to the longitudinal axis 50b of the machining tool 12b. In particular, the machining tool 12b can at least partially form the at least one antenna 24b and/or the at least one antenna 24b can be arranged at least partially on, in particular within, the machining tool 12b. Alternatively or additionally, it is conceivable for the at least one guide bar element 114b of the power tool device 10b, on which the machining tool 12b is at least partially mounted, to at least partially form the at least one antenna 24b and/or for the at least one antenna 24b, as for example in the present exemplary embodiment, to be arranged at least partially on, in particular within, the guide bar element 114b. Preferably, the at least one antenna 24b extends linearly.

FIG. 5 shows a circuit diagram of a part of the sensor unit 14b. The sensor unit 14b comprises preferably at least one electrical or electronic shielding circuit 154b, which is configured to shield an electric and/or magnetic field, emitted by the antenna 24b, in at least one emission direction. By means of the shielding circuit 154b, in particular an emission direction of the antenna 24b is settable. The shielding circuit 154b is preferably in the form of a high-impedance circuit. The shielding circuit 154b comprises preferably at least one high-impedance electrical component. In particular, the antenna 24b and/or at least one tuning circuit 158b of the sensor unit 14b is/are connected to an input of the shielding circuit 154b. Preferably, at least one output of the shielding circuit 154b is connected to ground 156b. Preferably, the shielding circuit 154b has a higher impedance at the input of the shielding circuit 154b than at the output of the shielding circuit 154b. For example, an order of magnitude of the impedance at the input of the shielding circuit 154b is 100 MΩ and an order of magnitude of the impedance at the output of the shielding circuit 154b is 10 MΩ. However, it is also conceivable in principle for the orders of magnitude at the input and output to be different than the abovementioned values.

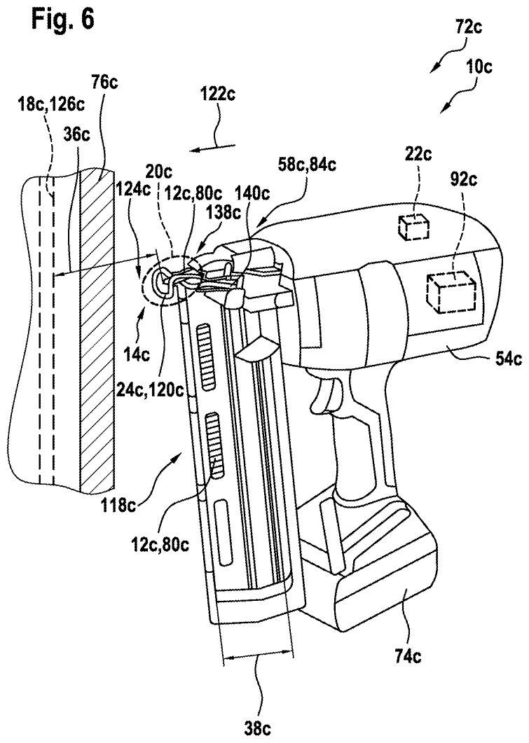

FIG. 6 shows a second alternative power tool 72c in a schematic perspective illustration. The power tool 72c is in particular in the form of a nail gun. The power tool 72c comprises in particular a power tool device 10c. Preferably, the power tool device 10c is intended to machine a workpiece 76c by nailing. Preferably, the power tool device 10c comprises at least one motor-drivable machining tool 12c, in particular a plurality of machining tools 12c. In particular, the machining tools 12c are in the form of nails 80c. Preferably, the power tool device 10c comprises at least one, in particular capacitive, sensor unit 14c, which is configured to sense at least one foreign body 18c in at least one detection area 20c around the machining tool 12c, in particular the machining tool 12c presently to be dispensed, and at least one open-loop and/or closed-loop control unit 22c, which is configured to trigger at least one action on the basis of at least one signal from the sensor unit 14c. Preferably, the sensor unit 14c comprises at least one antenna 24c, which is configured to emit at least one electric and/or magnetic field, which defines the at least one detection area 20c, and/or to sense the at least one foreign body 18c on the basis of at least one change in at least one electric and/or magnetic field.

Preferably, the open-loop and/or closed-loop control unit 22c is configured to trigger the at least one action on the basis of at least one parameter, in particular on the basis of at least one dimension 38c, of the machining tool 12c, in particular of the plurality of machining tools 12c. Preferably, the dimension 38c of the machining tools 12c is in the form of a maximum main extent of the machining tools 12c.

In particular, the open-loop and/or closed-loop control unit 22c can be configured to prevent the at least one action on the basis of the at least one parameter, in particular on the basis of the at least one dimension 38c, of the machining tools 12c. Preferably, the open-loop and/or closed-loop control unit 22c is configured to trigger the at least one action on the basis of the at least one dimension 38c, in particular on the basis of the maximum main extent, of the machining tools 12c in the form of nails 80c. In particular, the open-loop and/or closed-loop control unit 22c is configured to control at least one dispensing unit 58c of the power tool device 10c, which is intended to dispense the machining tools 12c in the form of nails 80c, on the basis of the at least one dimension 38c, in particular on the basis of the maximum main extent, of the machining tools 12c in the form of nails 80c. In particular, it is conceivable for the open-loop and/or closed-loop control unit 22c to be configured to trigger dispensing of the machining tools 12c in the form of nails 80c on the basis of the dimension 38c, in particular the maximum main extent, of the machining tools 12c in the form of nails 80c being smaller than a determined distance 36c between the sensed foreign body 18c and the machining tools 12c, in particular the machining tool 12c presently to be dispensed. In particular, it is conceivable for the open-loop and/or closed-loop control unit 22c to be configured to prevent dispensing of the machining tools 12c in the form of nails 80c on the basis of the dimension 38c, in particular the maximum main extent, of the machining tools 12c in the form of nails 80c being greater than the determined distance 36c between the sensed foreign body 18c and the machining tools 12c, in particular the machining tool 12c presently to be dispensed.

Preferably, the open-loop and/or closed-loop control unit 22c is configured to trigger the at least one action on the basis of at least one further parameter, for example a dispensing energy of the dispensing unit 58c, a material hardness of the workpiece 76c, a thickness of the workpiece 76c or the like. Alternatively or additionally to being in the form of a dimension 38c of the machining tools 12c, the at least one parameter of the machining tools 12c, in particular the at least one parameter of machining tools 12c that are not in the form of nails 80c, can also be in the form of a penetration depth of the machining tools 12c in the workpiece 76c, of an inertia characteristic of the machining tools 12c, of a rotational speed of the machining tools 12c or of some other parameter that appears to make sense to a person skilled in the art.

Preferably, the power tool device 10c comprises at least one dispensing unit 58c, in particular the abovementioned dispensing unit 58c, for dispensing the at least one machining tool 12c, wherein the open-loop and/or closed-loop control unit 22c is configured to control the dispensing unit 58c to prevent or to enable the dispensing of the at least one machining tool 12c on the basis of the at least one signal from the sensor unit 14c. Preferably, the dispensing unit 58c is intended to dispense the machining tools 12c in the form of nails 80c. In particular, the dispensing unit 58c is intended to shoot the machining tools 12c. In particular, the dispensing unit 58c is intended to dispense, in particular shoot, a plurality of machining tools 12c one after another. In particular, the power tool 72c in the form of a nail gun comprises the power tool device 10c that comprises the dispensing unit 58c. In particular, the power tool device 10c can comprise at least one magazine unit 118c, which is intended to receive a plurality of machining tools 12c and/or to feed the plurality of machining tools 12c to the dispensing unit 58c. Preferably, the dispensing unit 58c comprises at least one release bracket 120c, which, to enable dispensing of the machining tools 12c, in particular in addition to be controlled by the open-loop and/or closed-loop control unit 22c, is actuable, in particular pressable, in particular counter to a dispensing direction 122c of the dispensing unit 58c. Preferably, the release bracket 120c forms the antenna 24c of the sensor unit 14c. Alternatively or additionally, it is conceivable for the antenna 24c to be arranged on the release bracket 120c, on a machining tool outlet 138c and/or on a machining tool guide 140c of the dispensing unit 58c.

Preferably, the open-loop and/or closed-loop control unit 22c is configured to control the dispensing unit 58c to prevent the dispensing of the machining tools 12c on the basis of at least one signal from the sensor unit 14c corresponding to sensing of the at least one foreign body 18c in the detection area 20c, in particular in a dispensing area 124c of the dispensing unit 58c. In the present exemplary embodiment, the foreign body 18c, in particular in the form of a power line 126c, is arranged in the dispensing area 124c of the dispensing unit 58c, in particular in the vicinity of the workpiece 76c, which is in particular in the form of wall cladding. In particular, it is conceivable for the open-loop and/or closed-loop control unit 22c to additionally be configured to trigger an output of a warning signal on the basis of the signal from the sensor unit 14c corresponding to the sensing of the foreign body 18c in the detection area 20c, in particular in the dispensing area 124c of the dispensing unit 58c. Preferably, the open-loop and/or closed-loop control unit 22c is configured to control the dispensing unit 58c to release the machining tools 12c on the basis of at least one signal from the sensor unit 14c corresponding to a lack of sensing of a foreign body 18c in the detection area 20c, in particular in the dispensing area 124c of the dispensing unit 58c. In particular, the open-loop and/or closed-loop control unit 22c can be configured to compare a determined position of the sensed foreign body 18c with the dispensing area 124c of the dispensing unit 58c and to control the dispensing unit 58c in particular on the basis of the comparison. In particular, the open-loop and/or closed-loop control unit 22c can be configured to control the dispensing unit 58c to release the machining tools 12c on the basis of at least one signal from the sensor unit 14c corresponding to sensing of at least one foreign body 18c in the detection area 20c and on the basis of a determined position of the foreign body 18c outside the dispensing area 124c of the dispensing unit 58c.

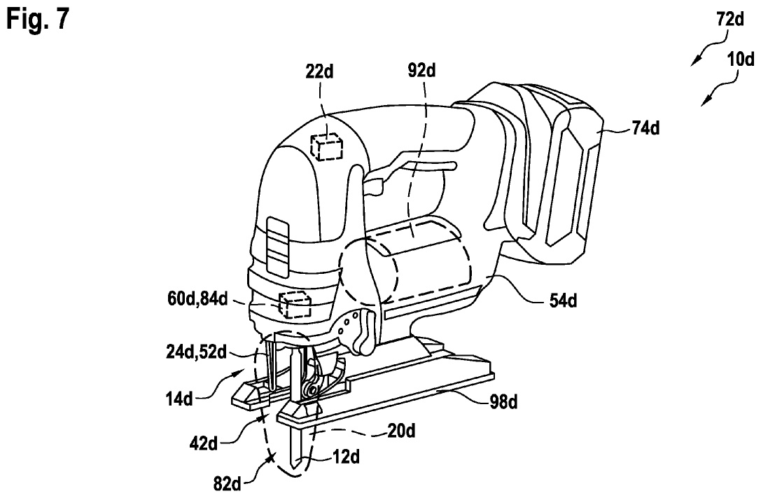

FIG. 7 shows a third alternative power tool 72d in a schematic perspective illustration. The power tool 72d is in particular in the form of a jigsaw. The power tool 72d comprises in particular a power tool device 10d. Preferably, the power tool device 10d is intended to machine a workpiece by cutting and/or sawing. Preferably, the power tool device 10d comprises at least one motor-drivable machining tool 12d. In particular, the machining tool 12d is in the form of a saw blade, in particular of a jigsaw blade. Preferably, the power tool device 10d comprises at least one, in particular capacitive, sensor unit 14d, which is configured to sense at least one foreign body in at least one detection area 20d around the machining tool 12d, and at least one open-loop and/or closed-loop control unit 22d, which is configured to trigger at least one action on the basis of at least one signal from the sensor unit 14d. Preferably, the sensor unit 14d comprises at least one antenna 24d, which is configured to emit at least one electric and/or magnetic field, which defines the at least one detection area 20d, and/or to sense the at least one foreign body on the basis of at least one change in at least one electric and/or magnetic field. Preferably, the open-loop and/or closed-loop control unit 22d is configured to trigger at least one braking of the machining tool 12d on the basis of the at least one signal from the sensor unit 14d corresponding to sensing of a foreign body in the detection area 20d, in particular by controlling a mechanical brake unit 60d of the power tool device 10d.

Preferably, the at least one antenna 24d is integrated in at least one mechanical protective element 52d in the vicinity 42d of the machining tool 12d, and/or the at least one antenna 24d is configured to replace the mechanical protective element 52d. Preferably, the power tool device 10d has the mechanical protective element 52d for protecting the machining tool 12d, in particular from foreign bodies, and/or for protecting foreign bodies, in particular body parts of a user, from the machining tool 12d. The mechanical protective element 52d is arranged in particular in the vicinity 42d of the machining tool 12d. Preferably, the mechanical protective element 52d covers the machining tool 12d at least partially, and encloses the machining tool 12d in particular at least partially. Preferably, the mechanical protective element 52d is in the form of a guard bracket, as for example in the present exemplary embodiment, of a protective hood or of some other mechanical protective element that appears to make sense to a person skilled in the art. In particular, the mechanical protective element 52d can at least partially form the at least one antenna 24d, in particular be formed from a metal, and/or the at least one antenna 24d can be arranged at least partially on, in particular within, the mechanical protective element 52d. In the present exemplary embodiment, the mechanical protective element 52d forms the antenna 24d for example. Alternatively, it is conceivable for the antenna 24d to be arranged on, in particular within, a guide element 98d of the power tool device 10d, in particular a sliding shoe, and/or the machining tool 12d, and/or to be formed by the machining tool 12d. Also alternatively, it is conceivable for the at least one antenna 24d to be configured to replace the mechanical protective element 52d, in particular a protective function of the mechanical protective element 52d. In particular, the at least one antenna 24d is configured to provide virtual shielding of the machining tool 12d, in particular in the form of the detection area 20d. In particular, as an alternative to mechanical protection by the mechanical protective element 52d, in order to reduce a risk of injury by the machining tool 12d and/or a risk of damage to the machining tool 12d, the at least one action, in particular braking of the machining tool 12d, moving the machining tool 12d away from a risk area 82d, mechanical shielding of the machining tool 12d or the like is able to be triggered on the basis of sensing of the foreign body by the at least one antenna 24d. In particular, the power tool device 10d can, in an alternative configuration, be formed free of the mechanical protective element 52d.

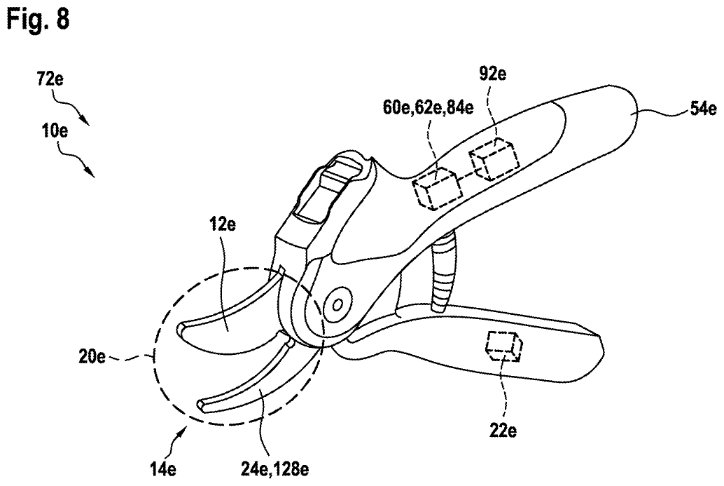

FIG. 8 shows a fourth alternative power tool 72e in a schematic perspective illustration. The power tool 72e is in particular in the form of garden shears. The power tool 72e comprises in particular a power tool device 10e. Preferably, the power tool device 10e is intended to machine a workpiece by cutting. Preferably, the power tool device 10e comprises at least one motor-drivable machining tool 12e. In particular, the power tool device 10e comprises a further, in particular stationary, machining tool 128e, which is intended to cooperate with the motor-drivable machining tool 12e. In particular, the machining tools 12e, 128e are in the form of blades. Preferably, the power tool device 10e comprises at least one, in particular capacitive, sensor unit 14e, which is configured to sense at least one foreign body in at least one detection area 20e around the machining tools 12e, 128e, and at least one open-loop and/or closed-loop control unit 22e, which is configured to trigger at least one action on the basis of at least one signal from the sensor unit 14e. Preferably, the sensor unit 14e comprises at least one antenna 24e, which is configured to emit at least one electric and/or magnetic field, which defines the at least one detection area 20e, and/or to sense the at least one foreign body on the basis of at least one change in at least one electric and/or magnetic field. In particular, the further machining tool 128e forms the antenna 24e. Alternatively or additionally, it is conceivable for the machining tool 12e to form the antenna 24e and/or for the antenna 24e to be arranged on, in particular within, the machining tool 12e and/or the further machining tool 128e.

Preferably, the power tool device 10e comprises at least one mechanical brake unit 60e that is controllable by the open-loop and/or closed-loop control unit 22e, is intended to brake the machining tool 12e and is at least partially in the form of at least one self-locking gear 62e, in particular of a worm gear. Preferably, the mechanical brake unit 60e is intended to mechanically brake the at least one, in particular moving, machining tool 12e, in particular until the machining tool 12e is at a standstill. In particular, the mechanical brake unit 60e, in particular in addition to being at least partially formed by the self-locking gear 62e, may comprise at least one mechanical brake element, in particular a brake shoe, a wrap spring, a blocking pin or the like, which, to effect active braking of the machining tool 12e, is able to be coupled by a force- and/or form-fit to the machining tool 12e and/or to an output shaft (not illustrated here). Preferably, the mechanical brake unit 60e is intended to brake the machining tool 12e at the latest 200 milliseconds after triggering of the mechanical braking, until the machining tool 12e is at a standstill.

Preferably the power tool 72e in the form of garden shears comprises the power tool device 10e that comprises the mechanical brake unit 60e which is formed at least partially by the at least one self-locking gear 62e, in particular by the worm gear. Preferably, the gear 62e is intended to transform a movement of a motor 92e of the power tool device 10e into a drive for the at least one machining tool 12e. Preferably, the gear 62e and the motor 92e are provided for motor support of manual actuation of the at least one machining tool 12e, in particular a cutting movement of the garden shears. Preferably, the gear 62e has a transmission ratio, in particular of a speed of the motor 92e to a speed of the machining tool 12e, of at least 1:50, preferably of at least 1:75 and particularly preferably of at least 1:100. Preferably, the gear 62e is able to be driven via a driveshaft of the motor 92e. Preferably, the gear 62e is not able to be driven via the output shaft, on which the machining tool 12e is mounted. Preferably, the gear 62e is in the form of a dynamically self-locking gear. In particular, the gear 62e is in the form of a worm gear which has a maximum degree of efficiency of less than 0.5. Preferably, the gear 62e is intended to stop a movement of the at least one machining tool 12e on the basis of a stopping of the motor 92e. In particular, the open-loop and/or closed-loop control unit 22e is configured to effect and/or trigger motor braking of the motor 92e on the basis of at least one signal from the sensor unit 14e. In particular, the open-loop and/or closed-loop control unit 22e is configured to switch off, to short-circuit, to reverse the polarity of or similarly act on the motor 92e, in particular electric motor, driving the machining tool 12e, in order to effect motor braking.

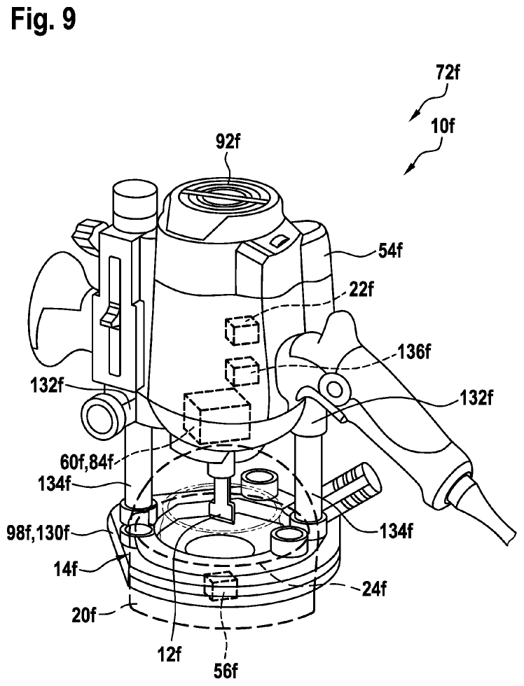

FIG. 9 shows a fifth alternative power tool 72f in a schematic perspective illustration. The power tool 72f is in particular in the form of a milling machine, in particular of a router. The power tool 72f comprises in particular a power tool device 10f. Preferably, the power tool device 10f is intended to machine a workpiece by milling. Preferably, the power tool device 10f comprises at least one motor-drivable machining tool 12f, in particular a milling tool. Preferably, the power tool device 10f comprises at least one, in particular capacitive, sensor unit 14f, which is configured to sense at least one foreign body in at least one detection area 20f around the machining tool 12f, and at least one open-loop and/or closed-loop control unit 22f, which is configured to trigger at least one action on the basis of at least one signal from the sensor unit 14f. Preferably, the sensor unit 14f comprises at least one antenna 24f, which is configured to emit at least one electric and/or magnetic field, which defines the at least one detection area 20f, and/or to sense the at least one foreign body on the basis of at least one change in at least one electric and/or magnetic field.

Preferably, the open-loop and/or closed-loop control unit 22f is configured to trigger at least one braking of the machining tool 12f on the basis of the at least one signal from the sensor unit 14f corresponding to sensing of a foreign body in the detection area 20f, in particular by controlling a mechanical brake unit 60f of the power tool device 10f. Alternatively or additionally, it is conceivable for the power tool device 10f to have at least one protective unit and/or a retraction unit, which is/are controllable by the open-loop and/or closed-loop control unit 22f on the basis of the at least one signal from the sensor unit 14f.

Preferably, the power tool device 10f comprises at least one housing 54f from which the sensor unit 14f is able to be uncoupled, wherein the sensor unit 14f has at least one, in particular wireless, communications unit 56f for providing the at least one signal to the open-loop and/or closed-loop control unit 22f. In particular, the power tool device 10f can be operable in a state uncoupled from the sensor unit 14f, in particular in a state free from a connection for signal transmission purposes between the sensor unit 14f and the open-loop and/or closed-loop control unit 22f, in particular free of comfort functions and safety functions based on the sensor unit 14f. Preferably, the sensor unit 14f is able to be used with, in particular able to be coupled to, different power tool devices 10f. Preferably, the housing 54f of the power tool device 10f and the sensor unit 14f, in particular a housing 130f of the sensor unit 14f, can have coupling interfaces 132f, 134f, for example bayonet connections, latching elements, plugs or the like, for mechanical, in particular mechanical and electrical, coupling. The housing 130f of the sensor unit 14f forms in particular a guide element 98f, in particular a sliding shoe. In particular, the antenna 24f is arranged on, in particular within, the housing 130f of the sensor unit 14f. In the present exemplary embodiment, the housing 54f of the power tool device 10f and the sensor unit 14f, in particular the housing 130f of the sensor unit 14f, have for example mechanical coupling interfaces 132f, 134f. In particular, the sensor unit 14f, in particular the housing 130f of the sensor unit 14f, has two coupling interfaces 134f in the form of coupling rods. In particular, the housing 54f of the power tool device 10f has two coupling interfaces 132f, in the form of coupling receptacles, for receiving the coupling interfaces 134f of the sensor unit 14f. In particular, in an alternative configuration, an electrical coupling interface can at least partially form the communications unit 56f of the sensor unit 14f and/or a communications unit 136f of the power tool device 10f. In particular, the communications unit 56f of the sensor unit 14f is configured to transmit the at least one signal to the open-loop and/or closed-loop control unit 22f via the communications unit 136f of the power tool device 10f. The communications unit 56f, 136f, in the form of a wireless communications unit, of the sensor unit 14f and/or of the power tool device 10f can in particular be in the form of a WLAN module, of a radio module, of a Bluetooth module, of an NFC module or the like. A communications unit 56f, 136f, in the form of a wired communications unit in an alternative configuration, of the sensor unit 14f and/or of the power tool device 10f can, alternatively or additionally to being formed by the at least one coupling interface 132f, 134f, be in particular in the form of a USB connection, of an Ethernet connection, of a coaxial connection or the like.

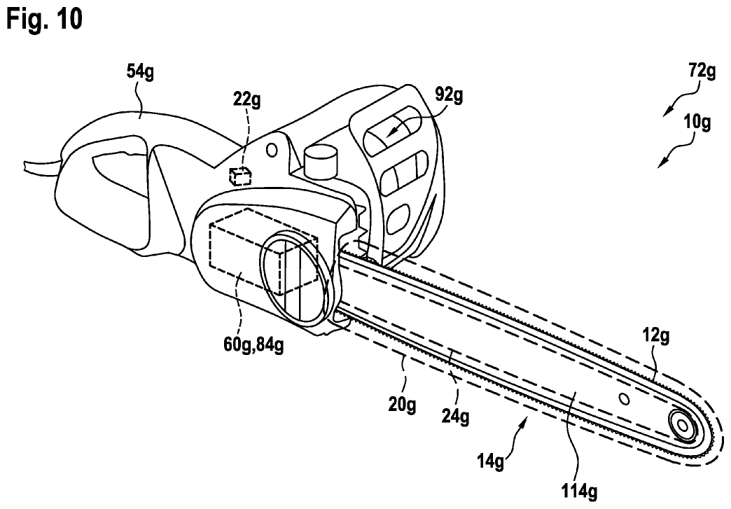

FIG. 10 shows a sixth alternative power tool 72g in a schematic perspective illustration. The power tool 72g is in particular in the form of a saw, in particular of a chain saw. The power tool 72g comprises in particular a power tool device 10g. Preferably, the power tool device 10g is intended to machine a workpiece by cutting and/or sawing. Preferably, the power tool device 10g comprises at least one motor-drivable machining tool 12g, in particular a saw chain. In particular, the machining tool 12g is mounted on a guide bar element 114g of the power tool device 10g. Preferably, the power tool device 10g comprises at least one, in particular capacitive, sensor unit 14g, which is configured to sense at least one foreign body in at least one detection area 20g around the machining tool 12g, and at least one open-loop and/or closed-loop control unit 22g, which is configured to trigger at least one action on the basis of at least one signal from the sensor unit 14g. Preferably, the sensor unit 14g comprises at least one antenna 24g, which is configured to emit at least one electric and/or magnetic field, which defines the at least one detection area 20g, and/or to sense the at least one foreign body on the basis of at least one change in at least one electric and/or magnetic field. The antenna 24g is arranged in particular on, in particular within, the guide bar element 114g. In particular, the antenna 24g extends non-linearly. Preferably, the antenna 24g is arranged parallel to the machining tool 12g. Alternatively or additionally, it is conceivable for the guide bar element 114g and/or the machining tool 12g to form the antenna 24g and/or for the antenna 24g to be arranged on, in particular within, the machining tool 12g. Preferably, the open-loop and/or closed-loop control unit 22g is configured to trigger at least one braking of the machining tool 12g on the basis of the at least one signal from the sensor unit 14g corresponding to sensing of a foreign body in the detection area 20g, in particular by controlling a mechanical brake unit 60g of the power tool device 10g. Preferably, the mechanical brake unit 60g is in the form of a band brake and/or provided in addition to a band brake. Alternatively or additionally, it is conceivable for the open-loop and/or closed-loop control unit 22g to be configured to trigger moving of a recoil bracket of the power tool device 10g in the direction of the machining tool 12g on the basis of the at least one signal from the sensor unit 14g corresponding to sensing of a foreign body in the detection area 20g.

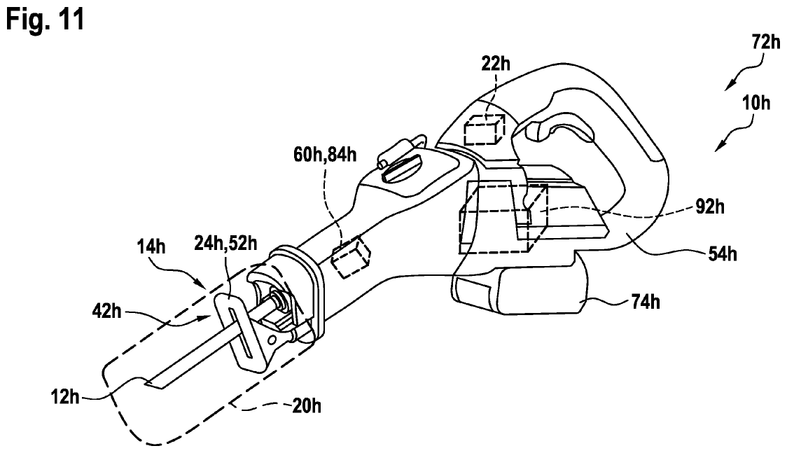

FIG. 11 shows a seventh alternative power tool 72h in a schematic perspective illustration. The power tool 72h is in particular in the form of a saw, in particular of a reciprocating saw. The power tool 72h comprises in particular a power tool device 10h. Preferably, the power tool device 10h is intended to machine a workpiece by cutting and/or sawing. Preferably, the power tool device 10h comprises at least one motor-drivable machining tool 12h, in particular a saw blade. Preferably, the power tool device 10h comprises at least one, in particular capacitive, sensor unit 14h, which is configured to sense at least one foreign body in at least one detection area 20h around the machining tool 12h, and at least one open-loop and/or closed-loop control unit 22h, which is configured to trigger at least one action on the basis of at least one signal from the sensor unit 14h. Preferably, the sensor unit 14h comprises at least one antenna 24h, which is configured to emit at least one electric and/or magnetic field, which defines the at least one detection area 20h, and/or to sense the at least one foreign body on the basis of at least one change in at least one electric and/or magnetic field. Preferably, a mechanical protective element 52h of the power tool device 10h in the vicinity 42h of the machining tool 12h forms the antenna 24h. Preferably, the open-loop and/or closed-loop control unit 22h is configured to trigger at least one braking of the machining tool 12h on the basis of the at least one signal from the sensor unit 14h corresponding to sensing of a foreign body in the detection area 20h, in particular by controlling a mechanical brake unit 60h of the power tool device 10h.

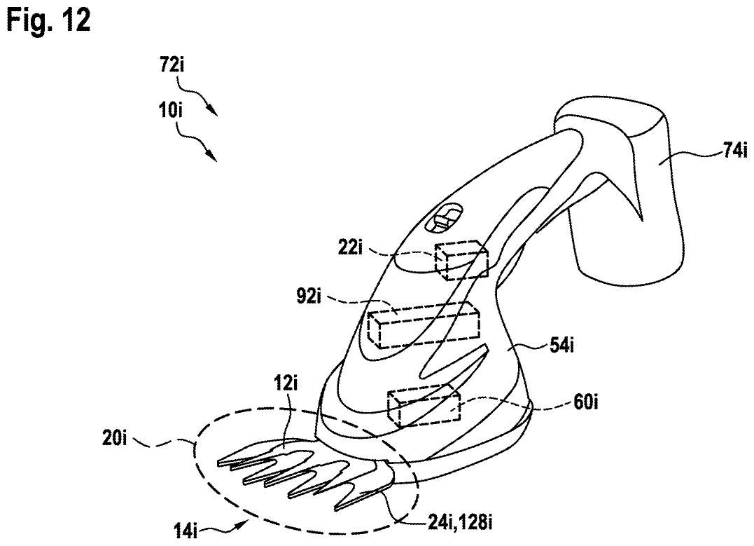

FIG. 12 shows an eighth alternative power tool 72i in a schematic perspective illustration. The power tool 72i is in particular in the form of shears, in particular of grass shears. The power tool 72i comprises in particular a power tool device 10i. Preferably, the power tool device 10i is intended to machine a workpiece by cutting. Preferably, the power tool device 10i comprises at least one motor-drivable machining tool 12i, in particular a blade. In particular, the power tool device 10i comprises a further, in particular stationary machining tool 128i, in particular a blade, which is intended to cooperate with the machining tool 12i. Preferably, the power tool device 10i comprises at least one, in particular capacitive, sensor unit 14i, which is configured to sense at least one foreign body in at least one detection area 20i around the machining tools 12i, 128i, and at least one open-loop and/or closed-loop control unit 22i, which is configured to trigger at least one action on the basis of at least one signal from the sensor unit 14i. Preferably, the sensor unit 14i comprises at least one antenna 24i, which is configured to emit at least one electric and/or magnetic field, which defines the at least one detection area 20i, and/or to sense the at least one foreign body on the basis of at least one change in at least one electric and/or magnetic field. Preferably, the further, in particular stationary, machining tool 128i forms the antenna 24i. Alternatively or additionally, it is conceivable for the machining tool 12i to form the antenna 24i and/or for the antenna 24i to be arranged on, in particular within, the machining tool 12i and/or the further machining tool 128i. Preferably, the open-loop and/or closed-loop control unit 22i is configured to trigger at least one braking of the machining tool 12i on the basis of the at least one signal from the sensor unit 14i corresponding to sensing of a foreign body in the detection area 20i, in particular by controlling a mechanical brake unit 60i of the power tool device 10i.

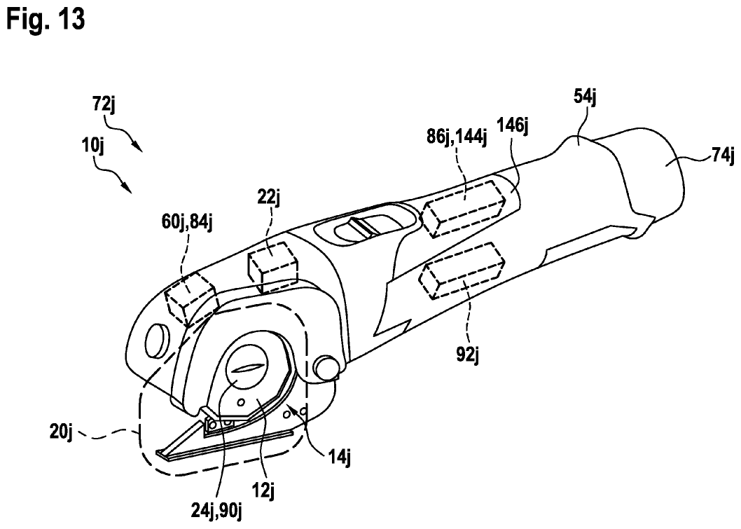

FIG. 13 shows a ninth alternative power tool 72j in a schematic perspective illustration. The power tool 72j is in particular in the form of shears, in particular of universal shears. The power tool 72j comprises in particular a power tool device 10j. Preferably, the power tool device 10j is configured to machine a workpiece by cutting. Preferably, the power tool device 10j comprises at least one motor-drivable machining tool 12j, in particular a rotary blade. Preferably, the power tool device 10j comprises at least one, in particular capacitive, sensor unit 14j, which is configured to sense at least one foreign body in at least one detection area 20j around the machining tool 12j, and at least one open-loop and/or closed-loop control unit 22j, which is configured to trigger at least one action on the basis of at least one signal from the sensor unit 14j. Preferably, the sensor unit 14j comprises at least one antenna 24j, which is configured to emit at least one electric and/or magnetic field, which defines the at least one detection area 20j, and/or to sense the at least one foreign body on the basis of at least one change in at least one electric and/or magnetic field.

Preferably, an output shaft 90j, on which the machining tool 12j is mounted, forms the antenna 24j. Alternatively or additionally, it is conceivable for the machining tool 12j to form the antenna 24j and/or for the antenna 24j to be arranged on, in particular within, the machining tool 12j and/or the output shaft 90j. Preferably, the open-loop and/or closed-loop control unit 22j is configured to trigger braking of the machining tool 12j on the basis of a signal from the sensor unit 14j corresponding to sensing of a foreign body in the detection area 20j, in particular by controlling a mechanical brake unit 60j of the power tool device 10j. Alternatively or additionally, it is conceivable for the open-loop and/or closed-loop control unit 22j to be configured to trigger an output of an, in particular haptic, warning signal on the basis of the signal from the sensor unit 14j corresponding to sensing of a foreign body in the detection area 20j, in particular by controlling a vibratory unit 144j of the power tool device 10j. The vibratory unit 144j is arranged in particular on a housing 54j of the power tool device 10j, in particular on a handle 146j formed at least partially by the housing 54j.

1. A power tool device comprising:
at least one motor-drivable machining tool;
at least one sensor unit configured to sense at least one foreign body in at least one detection area around the at least one machining tool; and
at least one open-loop and/or closed-loop control unit configured to trigger at least one action based on at least one signal from the at least one sensor unit,
wherein the at least one sensor unit comprises at least one antenna configured (i) to emit at least one electric and/or magnetic field defining the at least one detection area, and/or (ii) to sense the at least one foreign body based on at least one change in the at least one electric and/or magnetic field.

2. The power tool device as claimed in claim 1, wherein the at least one sensor unit further comprises at least one field shielding element formed integrally with the at least one antenna and configured to shield the at least one electric and/or magnetic field emitted by the at least one antenna in at least one emission direction.

3. The power tool device as claimed in claim 1, wherein the at least one sensor unit further comprises at least one electrical or electronic shielding circuit configured to shield the at least one electric and/or magnetic field emitted by the at least one antenna in at least one emission direction.

4. The power tool device as claimed in claim 1, wherein the at least one open-loop and/or closed-loop control unit is configured to determine at least one movement characteristic of the at least one foreign body and/or at least one distance of the at least one foreign body from the at least one machining tool based on the at least one signal from the at least one sensor unit.

5. The power tool device as claimed in claim 1, wherein the at least one open-loop and/or closed-loop control unit is configured to trigger different actions based on different determined movement characteristics of the at least one foreign body and/or based on different determined distances of the at least one foreign body from the at least one machining tool.

6. The power tool device as claimed in claim 4, wherein the at least one open-loop and/or closed-loop control unit is configured to determine a probability of contact of the at least one foreign body with the moving at least one machining tool based on the at least one movement characteristic of the at least one foreign body and/or of the at least one distance of the at least one foreign body from the at least one machining tool and based on a minimum time for braking the at least one machining tool to a standstill.

7. The power tool device as claimed in claim 6, wherein the at least one open-loop and/or closed-loop control unit is configured to trigger a different action based on the probability of contact being below a probability threshold value than based on the probability of contact being above the probability threshold value.

8. The power tool device as claimed in claim 1, wherein the at least one open-loop and/or closed-loop control unit is configured to classify the at least one foreign body sensed by the at least one sensor unit and to trigger different actions based on different classifications.

9. The power tool device as claimed in claim 1, wherein:
the at least one open-loop and/or closed-loop control unit is configured to trigger the at least one action based on at least one parameter, and
the at least one parameter includes at least one dimension of the at least one machining tool.

10. The power tool device as claimed in claim 1, further comprising:
at least one further sensor unit having at least one contact sensor element arranged in a vicinity, in a form of a guide region, of the at least one machining tool, the at least one further sensor unit configured to sense at least one body part of a user of the power tool device.

11. The power tool device as claimed in claim 10, wherein the at least one open-loop and/or closed-loop control unit is configured to adapt at least one parameter, at least partially autonomously based on at least one signal from the at least one further sensor unit.

12. The power tool device as claimed in claim 1, wherein the at least one antenna is configured as a ring about a longitudinal axis of the at least one machining tool.

13. The power tool device as claimed in claim 1, wherein the at least one antenna is arranged parallel to a longitudinal axis of the at least one machining tool.

14. The power tool device as claimed in claim 1, wherein:
the at least one antenna is integrated in at least one mechanical protective element in a vicinity of the at least one machining tool, and/or
the at least one antenna is configured to replace the at least one mechanical protective element.

15. The power tool device as claimed in claim 1, further comprising:
at least one housing from which the at least one sensor unit is configured to be uncoupled,
wherein the at least one sensor unit has at least one wireless communications unit configured to provide the at least one signal to the at least one open-loop and/or closed-loop control unit.

16. The power tool device as claimed in claim 1, further comprising:
at least one dispensing unit configured to dispense the at least one machining tool,
wherein the at least one open-loop and/or closed-loop control unit is configured to control the at least one dispensing unit to prevent or to enable the dispensing of the at least one machining tool based on the at least one signal from the at least one sensor unit.

17. The power tool device as claimed in claim 1, further comprising:
at least one mechanical brake unit configured (i) for control by the at least one open-loop and/or closed-loop control unit, and (ii) to brake the at least one machining tool, the at least one mechanical brake unit including a worm gear.

18. The power tool device as claimed in claim 1, further comprising:
at least one protective unit including at least one shielding element,
wherein the at least one open-loop and/or closed-loop control unit is configured to control the at least one protective unit to move the at least one shielding element around the at least one machining tool based on the at least one signal from the at least one sensor unit.

19. The power tool device as claimed in claim 1, further comprising:
at least one retraction unit,
wherein the open-loop and/or closed-loop control unit is configured to control the at least one retraction unit to move the at least one machining tool out of a machining area based on the at least one signal from the at least one sensor unit.

20. A method for operating the power tool device as claimed in claim 1, comprising:
emitting the at least one electric and/or magnetic field with the at least one antenna, the at least one electric and/or magnetic field defining the at least one detection area about the at least one machining tool of the power tool device; and/or
sensing, using the at least one antenna, the at least one foreign body is sensed based on the at least one change in the at least one electric and/or magnetic field.

21. (canceled)
